(19) United States
(12) Patent Application Publication
(10) Pub. No.: US 2007/0101290 A1
(43) Pub. Date: May 3, 2007

(54) Display apparatus

(75) Inventors: Yasuo Nakashima, Hekinan-city (JP); Masakazu Itou, Anjo-city (JP); Makoto Ooe, Kariya-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 11/586,622

(22) Filed: Oct. 26, 2006

(30) Foreign Application Priority Data
Oct. 31, 2005 (JP) 2005-315745

(51) Int. Cl. G01C 21/00

(52) U.S. Cl. 715/797; 715/781; 701/213

(57) ABSTRACT

A display apparatus includes a rendering unit, a priority determination unit, and a synthesized screen generation unit. The rendering unit determines necessary virtual screens based on an instruction signal from a navigation unit and information processing units. The priority determination unit determines a display priority based on a display content with respect to each virtual screen. The synthesized screen generation unit generates a synthesized screen to be displayed, by overlapping the determined virtual screens based on the determined display priorities. In this configuration, a certain window in a virtual screen, which has been displayed second or later in the order of overlapping windows, may be newly assigned the highest display priority when a display content in the certain window is changed. This allows the certain window to be displayed topmost and easily viewed by a user.

### CROSS REFERENCE TO RELATED APPLICATION

This application is based on and incorporates herein by reference Japanese Patent Application No. 2005-315745 filed on Oct. 31, 2005.

### FIELD OF THE INVENTION

The present invention relates to a display apparatus. More specifically, the invention relates to a display apparatus capable of displaying multiple pieces of information on a display screen.

### BACKGROUND OF THE INVENTION

There is widely known a display apparatus for displaying multiple pieces of information on a display screen such as a display apparatus provided for a car navigation system. When the display screen displays multiple pieces of information, it may take time to determine which information is currently needed. A user may miss a chance to recognize the necessary information.

When a vehicle stops or runs at a low speed, the navigation system described in patent document 1 displays a detailed map on the display screen. When the vehicle runs at a specified speed or more, the system displays a less detailed map to fast understand the map information needed during running.

Patent Document 1: JP-2667383 B2

It may be possible to display multiple windows on the display screen as needed and allow the windows to display different information. Also in this case, however, the user may miss a chance to recognize the information in the simultaneously displayed respective windows. When the windows partially or completely overlap with each other, the user may highly possibly miss a chance to recognize the information displayed in the underlying window.

Even when display areas such as windows do not overlap with each other, the use of multiple display areas makes it difficult to find where the important information is displayed. As a result, there is a possibility to miss a chance to recognize the information.

### SUMMARY OF THE INVENTION

The present invention has been made in consideration of the foregoing. It is therefore an object of the present invention to provide a display apparatus that facilitates fast recognition of necessary information.

According to an aspect of the present invention, a display apparatus is provided as follows. Screen determination means determines information that includes a number of windows to be displayed in a display screen, a display range in each window, and a display content in each window. Image generation means generates an overall display image for the display screen based on information determined by the screen determination means and displays the generated image on the display screen. Priority determination means determines a display priority of a window based on a display content included in information determined by the screen determination means. When the screen determination means determines displaying a plurality of windows having display ranges to overlap with each other, the image generation means generates an overall image by determining an order of overlapping the plurality of windows based on display priorities determined by the priority determination means.

Under the above structure, when multiple windows are overlapped with each other to generate an overall image, a display priority is determined based on a display content and determines the order of the overlapping windows. A window may be displayed second or later in the order of overlapping windows before the display content is changed. Changing the display content may assign the highest display priority to the window. In this case, the window is displayed at the top, which makes it possible to easily view information in the window. A user can promptly and easily recognize the necessary information.

According to another aspect of the present invention, a display apparatus in a vehicle is provided as follows. A plurality of display areas are included as a display screen for simultaneously displaying information. A display control unit is included for controlling displaying information in the display screen. When normal information displayed in a certain display area of the plurality of display areas changes to predetermined abnormal information, the display control unit changes a display mode for the certain display area.

Under the above structure, when information displayed in the display area changes from normal to abnormal, the display area may be provided with a display mode that differs from the previous one. In this manner, a driver can easily notice a change in the display content of the display area and more promptly find abnormal information.

According to yet another aspect of the present invention, a method for displaying information is provided with the following: determining information that includes a number of windows to be displayed in a display screen, a display range in each window, and a display content in each window; determining a display priority of each window based on a display content of each window, when a plurality of windows having display ranges to overlap with each other are determined to be displayed; generating an overall display image for the display screen by determining an order of overlapping the plurality of windows based on display priorities determined; and displaying the generated image on the display screen.

### BRIEF DESCRIPTION OF THE DRAWINGS

FIG. 1 is a block diagram showing a construction of a display apparatus according to a first embodiment of the invention;

FIG. 2 is a block diagram showing in detail a construction of an information collection unit;

FIG. 3 is a block diagram showing in detail a function of a control unit as a display control unit;

FIG. 4 exemplifies a virtual screen generated in a rendering unit of FIG. 3 and a synthesized screen generated in a synthesized screen generation unit thereof;

FIG. 5 exemplifies part of a priority conversion table used in a priority determination unit of FIG. 3;

FIG. 6 shows a synthesized screen different from that shown in FIG. 4;

FIG. 7 shows a synthesized screen different from those shown in FIGS. 4 and 6;

FIG. 8 is a block diagram showing in detail a function of a control unit as a display control unit according to a second embodiment;

FIG. 9 shows an example of a highlight table used in a highlight unit in FIG. 8;

FIG. 10 shows a highlighted display frame in a vehicle information window;

FIG. 11 shows a highlight table used for a third embodiment;

FIG. 12 shows how a vehicle information window is enlarged to 200% and its display frame is highlighted;

FIG. 13 is a block diagram showing a construction of a display apparatus according to a fourth embodiment;

FIG. 14 is a block diagram showing in detail a control function of a control unit as a display control unit in FIG. 13;

FIG. 15 is a flowchart showing a process of a synthesized screen generation unit in FIG. 14;

FIG. 16 exemplifies a screen displayed on the display apparatus according to the fourth embodiment;

FIG. 17 exemplifies another screen displayed on the display apparatus according to the fourth embodiment, an example different from that shown in FIG. 16;

FIG. 18 is a block diagram showing a construction of a display apparatus according to a fifth embodiment;

FIG. 19 is a block diagram showing in detail a control function of a control unit as a display control unit in FIG. 18;

FIG. 20 exemplifies a display scale table in FIG. 19;

FIG. 21 exemplifies an overall image displayed on the display apparatus according to the fifth embodiment;

FIG. 22 is a block diagram showing a construction of a display apparatus according to a sixth embodiment;

FIG. 23 is a block diagram showing a function of a control unit as a display control unit in FIG. 22;

FIG. 24 exemplifies an overall image displayed on the display apparatus according to the sixth embodiment;

FIG. 25 exemplifies another overall image displayed on the display apparatus according to the sixth embodiment, an example different from that shown in FIG. 24;

FIG. 26 exemplifies another overall image displayed on the display apparatus according to the sixth embodiment, an example different from those shown in FIGS. 24 and 25;

FIG. 27 is a block diagram showing a construction of a display apparatus according to a seventh embodiment;

FIG. 28 shows the display unit in FIG. 27;

FIG. 29 is a flowchart showing processes in a state information reception unit, an error state determination unit, and an error information display determination unit of FIG. 27;

FIG. 30 shows a display example in a display area;

FIG. 31 shows a display example in the display area during the processes in FIG. 29;

FIG. 32 exemplifies an error information priority table used during the processes in FIG. 29; and

FIG. 33 shows an example displayed in the display area during the processes in FIG. 29 when an engine system information icon is selected.

### DETAILED DESCRIPTION OF THE PREFERRED EMBODIMENTS

Embodiments of the present invention will be described in further detail with reference to the accompanying drawings.

### First Embodiment

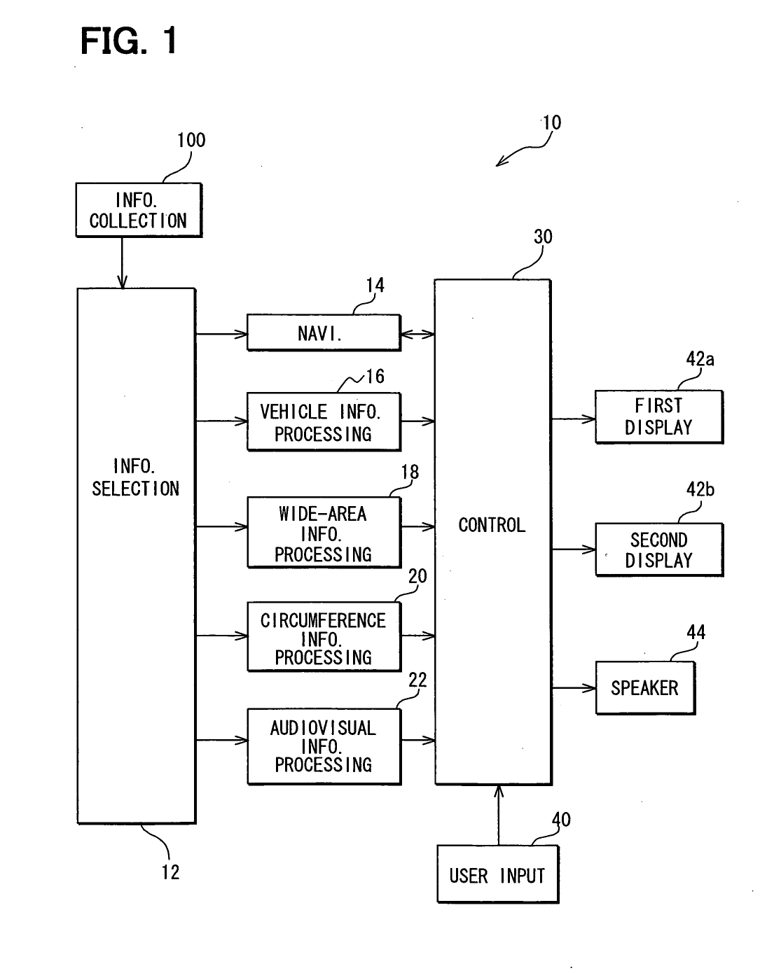

FIG. 1 is a block diagram showing the construction of a display apparatus 10 according to a first embodiment of the invention.

A display apparatus 10 mounted on a vehicle has an information collection unit 100 for collecting various information about the inside and the outside of the vehicle. Information collected in the information collection unit 100 is supplied to an information selection unit 12. The information selection unit 12 selects information needed for the navigation unit 14 and information processing units 16, 18, 20, and 22 from a variety of information supplied from the information collection unit 100. The information selection unit 12 outputs the selected information to the navigation unit 14 and the information processing units 16, 18, 20, and 22.

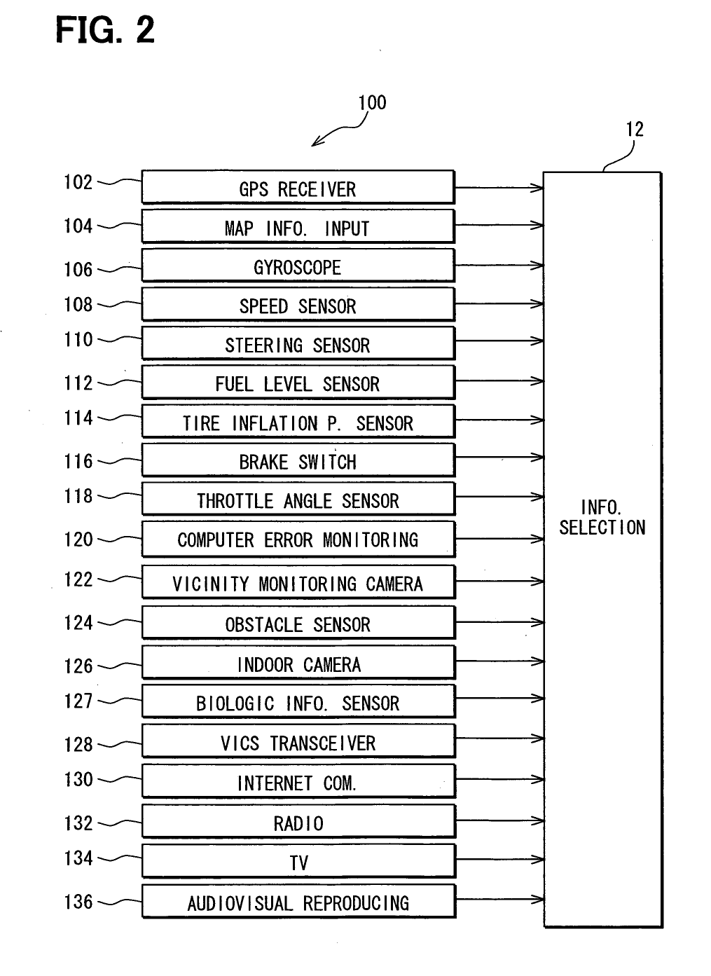

FIG. 2 is a block diagram showing in detail the construction of the information collection unit 100. The information collection unit 100 includes a GPS receiver 102, a map information input device 104, a gyroscope 106, a vehicle speed sensor 108, a steering sensor 110, a fuel level sensor 112, a tire inflation pressure sensor 114, a brake switch 116, a throttle angle sensor 118, an onboard computer error monitoring apparatus 120, a vicinity monitoring camera 122, an obstacle sensor 124, an indoor camera 126, a biologic information sensor 127, a VICS transceiver 128, an Internet communication apparatus 130, a radio set 132, a TV set 134, and an audiovisual reproducing apparatus 136.

The GPS receiver 102 is used for the global positioning system (GPS) that measures vehicle positions based on radio waves from satellites. The map information input device 104 is provided with a storage medium such as DVD-ROM or CD-ROM. The map information input device 104 reads map information stored in the storage medium and supplies the information to the information selection unit 12. The gyroscope 106 detects a relative orientation of the vehicle. The GPS receiver 102, the map information input device 104, and the gyroscope 106 collect the vehicle's position information.

The vehicle speed sensor 108 detects wheel revolutions to detect a vehicle speed. The steering sensor 110 detects a steering wheel angle. The fuel level sensor 112 detects the amount of fuel remaining in a fuel tank. The tire inflation pressure sensor 114 detects a tire inflation pressure. The brake switch 116 detects that a foot brake is operated. The throttle angle sensor 118 detects a throttle valve angle. The onboard computer error monitoring apparatus 120 monitors errors of various computers mounted in the vehicle. The onboard computer error monitoring apparatus 120 includes a diagnosis program stored in the computer of the apparatus itself or another computer. The vehicle speed sensor 108, the steering sensor 110, the fuel level sensor 112, the tire inflation pressure sensor 114, the brake switch 116, the throttle angle sensor 118, and the onboard computer error monitoring apparatus 120 collect the vehicle information.

The vicinity monitoring camera 122 is provided at a position capable of capturing a specified direction around the vehicle. The obstacle sensor 124 is provided to detect an obstacle in all directions, i.e., at 360 degrees, around the vehicle. The obstacle sensor 124 includes a specified number of sensors, e.g., four sensors to detect the front, rear, right side, and left side of the vehicle. The obstacle sensor 124 represents an ultrasonic sensor or a laser radar sensor. The obstacle sensor is also used to detect a distance between the vehicle and an obstacle. When another vehicle is assumed to be an obstacle, the obstacle sensor also functions as an inter-vehicle gap sensor. The vicinity monitoring camera 122 and the obstacle sensor 124 collect information around the vehicle.

The indoor camera 126 collects driver information. The indoor camera 126 is provided at a specified position in a vehicle compartment (e.g., on the ceiling at the front end of the compartment and at the center of the vehicle width direction). The indoor camera 126 chronologically (or time-sequentially) captures situations in the vehicle compartment, especially driver's situations. The biologic information sensor 127 also acquires the driver information. For example, the biologic information sensor 127 detects the driver's biologic information such as a heart rate and a breathing rate.

The VICS transceiver 128 receives information from a VICS (Vehicle Information and Communication System) (registered trademark) center via beacons installed on roads and local FM broadcasting stations. The VICS center provides information about road traffic, weather, date, facility, and advertisement. The Internet communication apparatus 130 is a wireless communication apparatus connectable to a public telephone line and connects to the Internet network via the public telephone line. The VICS transceiver 128 and the Internet communication apparatus 130 collect wide area information. That is, the VICS transceiver 128 and the Internet communication apparatus 130 collect information about an area wider than the vehicle vicinity about which information the vicinity monitoring camera 122 and the obstacle sensor 124 collect.

The audiovisual reproducing apparatus 136 can reproduce a music CD or a DVD that stores video such as movies. The audiovisual reproducing apparatus 136, the radio set 132, and the TV set 134 are mainly used to collect amusement information.

Referring back to FIG. 1, the navigation unit 14 processes the route guidance. Via the information selection unit 12, the navigation unit 14 is supplied with information from the GPS receiver 102, the map information input device 104, the gyroscope 106, and the vehicle speed sensor 108. A user operates a user input apparatus 40 to supply information about a destination and the like. This information is supplied to the navigation unit 14 via the control unit 30.

A vehicle information processing unit 16 determines the vehicle's running states such as an onboard device error and a running speed. Via the information selection unit 12, the vehicle information processing unit 16 is supplied with information from the vehicle speed sensor 108, the steering sensor 110, the fuel level sensor 112, the tire inflation pressure sensor 114, the brake switch 116, the throttle angle sensor 118, and the onboard computer error monitoring apparatus 120.

A wide-area information processing unit 18 processes the above-mentioned wide area information. Via the information selection unit 12, the wide-area information processing unit 18 is supplied with information from the VICS transceiver 128 and the Internet communication apparatus 130.

A circumference information processing unit 20 collects and processes information around the vehicle. Via the information selection unit 12, the circumference information processing unit 20 is supplied with information from the vicinity monitoring camera 122 and the obstacle sensor 124. The circumference information processing unit 20 is also supplied with vehicle information from the vehicle speed sensor 108.

The audiovisual information processing unit 22 processes signals from the radio set 132, the TV set 134, and the audiovisual reproducing apparatus 136. The audiovisual information processing unit 22 then determines a display content to be displayed on a display unit 42. The display content to be determined includes an operation screen for each apparatus and a motion picture.

The navigation unit 14 and the information processing units 16, 18, 20, and 22 each output a display instruction signal to the control unit 30 when determining display of information on the display unit 42. The display instruction signal instructs the display unit 42 to display the information.

The user input apparatus 40 includes a key input apparatus and a voice input apparatus. The key input apparatus enables user's manual input operation using a mechanical key or the like. The voice input apparatus has a voice input apparatus including a microphone and a voice recognition unit that analyzes voice supplied from the microphone.

According to the embodiment, the display unit 42 includes a first display unit 42a and a second display unit 42b. The following description simply concerns the display unit 42 unless distinguished specifically. The display unit 42 represents a liquid crystal display, for example. The first display unit 42a is provided in an instrument panel at the middle between a driver's seat and a passenger seat and displays a road map and the like. The second display unit 42b is provided in the instrument panel ahead of the driver's seat and displays a vehicle speed and the like.

The control unit 30 functions as a display control unit. The control unit 30 follows signals from the navigation unit 14 and the information processing units 16, 18, 20, and 22. Based on display contents determined by these units, the control unit 30 generates an overall image to be displayed on the display unit 42 and displays it on the display unit 42. The control unit 30 also functions as an output sound control unit. The control unit 30 follows signals from the navigation unit 14 and the information processing units 16, 18, 20, and 22 and allows the speaker 44 to output a specified sound.

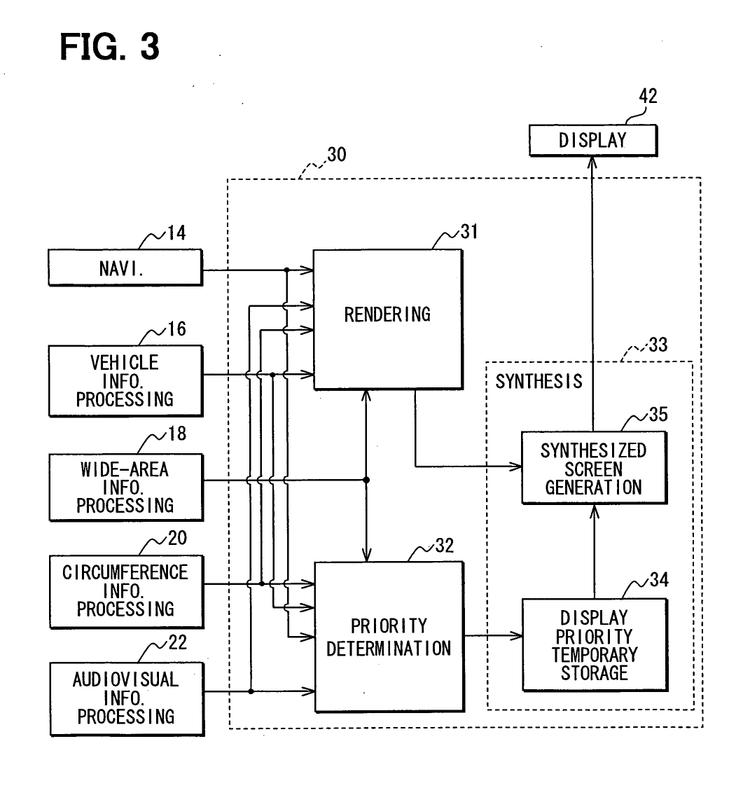

FIG. 3 is a block diagram showing in detail one of control functions of the control unit 30 as the display control unit. As shown in FIG. 3, the control unit 30 includes a rendering unit 31, a priority determination unit 32, and a synthesis unit 33 functioning as image generation means. Further, the synthesis unit 33 includes a display priority temporary storage unit 34 and a synthesized screen generation unit 35.

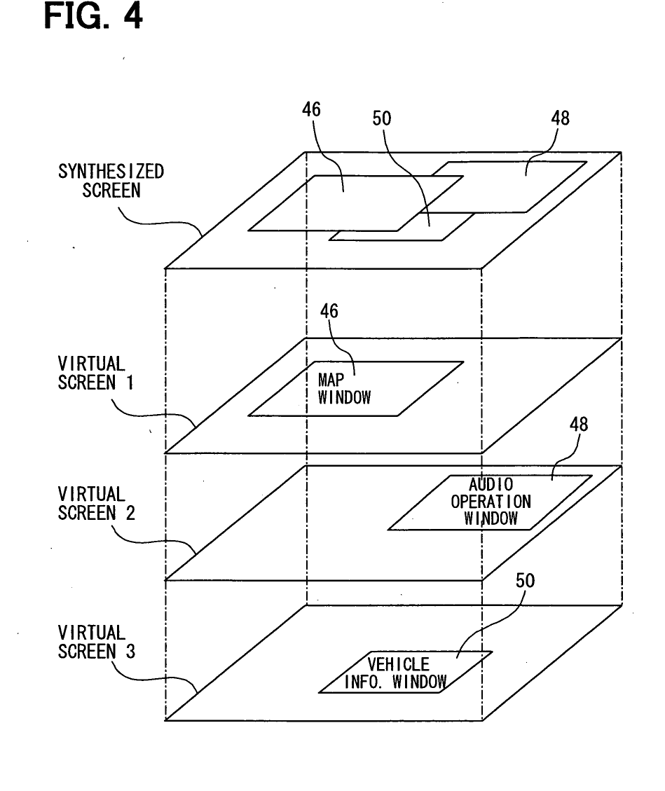

The rendering unit 31 functions as screen determination means. The rendering unit 31 follows display instruction signals from the outside, i.e., from the navigation unit 14 and the information processing units 16, 18, 20, and 22 to determine the necessary number of virtual screens. The virtual screen provides an image for the entire displayable range of the display unit 42 (one of the first display unit 42a and the second display unit 42b). As shown in FIG. 4, for example, the rendering unit 31 determines (renders) three virtual screens 1 through 3.

According to a display instruction signal from the navigation unit 14, the virtual screen 1 uses part of the displayable range to render a map window 46 showing a road map. The remaining part of the displayable range is filled with a background color. According to a display instruction signal from the audiovisual information processing unit 22, the virtual screen 2 uses part of the displayable range to render an audio operation window 48 for audio operation. The remaining part of the displayable range is filled with a background color. According to a display instruction signal from the vehicle information processing unit 16, the virtual screen 3 uses part of the displayable range to render a vehicle information window for displaying vehicle information. The remaining part of the displayable range is filled with a background color.

The rendering unit 31 determines the virtual screens as exemplified in FIG. 4. The rendering unit 31 determines the number of windows to be displayed on the display unit 42, a display range, and a display content in each window. In the example of FIG. 4, one virtual screen corresponds to one of the navigation unit 14 and the information processing units 16, 18, 20, and 22. Further, one virtual screen may render information about the multiple processing units 16, 18, 20, and 22, or the navigation unit 14.

The priority determination unit 32 functions as priority determination means. The priority determination unit 32 uses a pre-stored priority conversion table to determine a display priority for the virtual screen determined by the rendering unit 31.

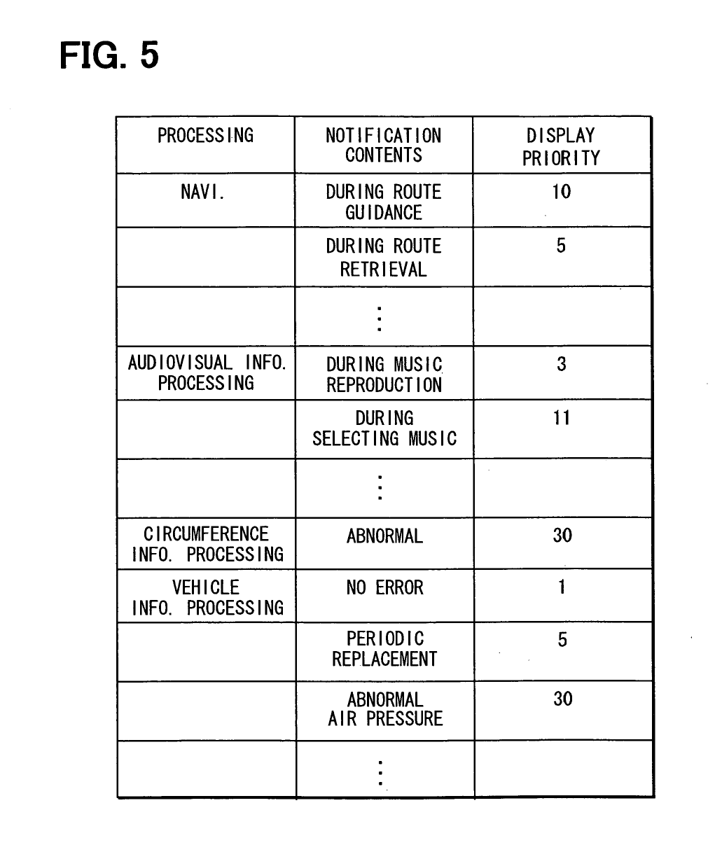

FIG. 5 exemplifies part of the priority conversion table. As shown in FIG. 5, the priority conversion table defines display priorities corresponding to notification contents (display contents displayed in the windows) of the processing units (the navigation unit 14 and the information processing units 16, 18, 20, and 22). Here, a larger number corresponds to a higher display priority. For instance, “30” is given the highest display priority and “1” is given the lowest display priority within the examples shown in FIG. 5. The priority conversion table in FIG. 5 may be used as follows. When the map window 46 in the virtual screen 1 of FIG. 4 contains a display content to be displayed during route guidance, the virtual screen 1 is assigned display priority 10. When the audio operation window 48 in the virtual screen 2 contains a display content to be displayed during music reproduction, the virtual screen 2 is assigned display priority 3. When the vehicle information window 50 in the virtual screen 3 shows no error, the virtual screen 3 is assigned display priority 1.

Referring back to FIG. 3, the display priority temporary storage unit 34 represents a temporary storage such as RAM. The display priority temporary storage unit 34 temporarily stores each virtual screen's display priority determined by the priority determination unit 32.

The synthesized screen generation unit 35 synthesizes all the virtual screens determined by the rendering unit 31 to generate a synthesized screen. At this time, window display ranges may overlap with each other. The synthesized screen generation unit 35 determines the order of overlapping windows so that the window having the highest display priority is displayed at the top, then the window having the next highest display priority is displayed next to the top window, and so on. For example, the synthesized screen generation unit 35 generates the synthesized screen as shown at the top in FIG. 4. The synthesized screen generation unit 35 outputs screen data for the synthesized screen to the display unit 42. In this manner, the display unit 42 displays the synthesized screen.

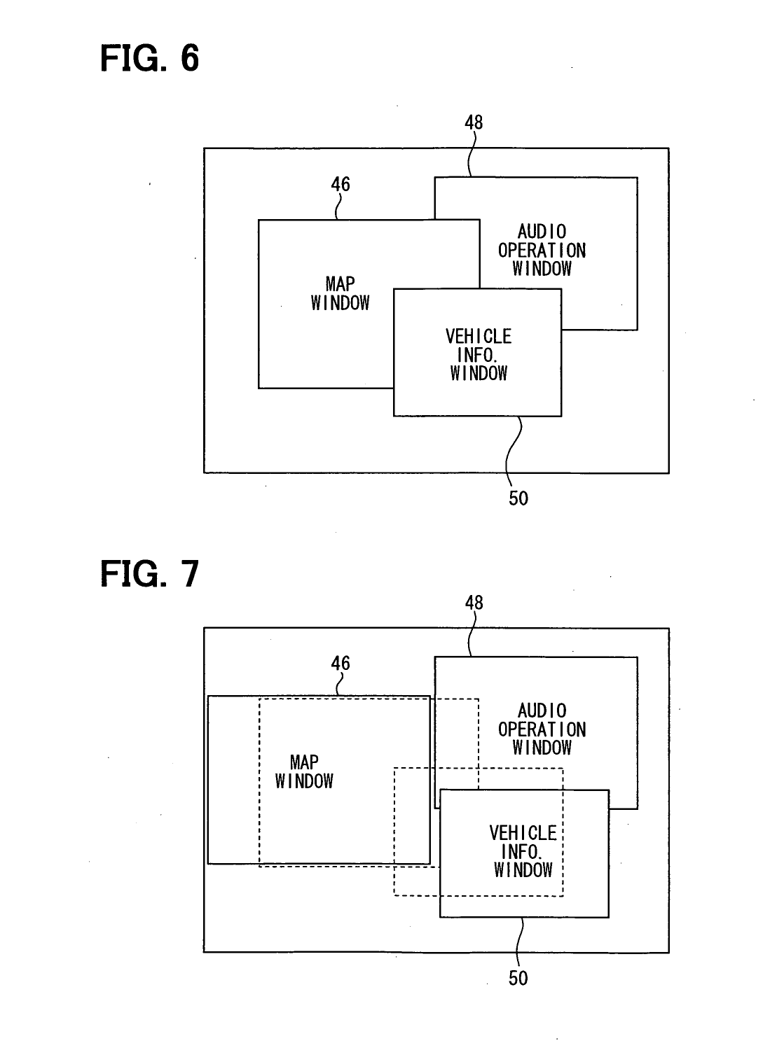

Let us suppose that the display contents of the map window 46 and the audio operation window 48 are unchanged, but the vehicle information window 50 changes its display content from “no error” to “abnormal air pressure.” In this case, the display priority for the vehicle information window changes to 30. As a result, the vehicle information window 50 is assigned the highest display priority. The order of three overlapping windows 46, 48, and 50 changes. The overall image generated by the synthesized screen generation unit 35 changes from the one displayed at the top of FIG. 4 to the one as shown in FIG. 6. That is, the vehicle information window 50 showing “abnormal air pressure” is displayed at the top for easy recognition. A driver can promptly notice the detection of abnormal air pressure.

Let us suppose that a change is made to the display content of the map window 46 in the screen of FIG. 6 and the display priority for the map window 46 changes from 10 to 30. As a result, the same display priority is assigned to the map window 46 and the vehicle information window 50. The highest display priority is assigned to the two windows. The rendering unit 31 determines the display ranges of the two windows 46 and 50 so that they overlap with each other. In this case, however, the synthesized screen generation unit 35 changes the display ranges determined by the rendering unit 31. As shown in FIG. 7, the synthesized screen generation unit 35 generates a synthesized screen so that the display ranges of the two windows 46 and 50 do not overlap with each other. Broken lines indicate the display ranges of the windows 46 and 50 before changing the display ranges (i.e., the display ranges of the windows 46 and 50 in FIG. 6).

Since the display ranges change, the user can simultaneously view all the windows 46 and 50 having the same display priority without needing to change the order of overlapping windows 46 and 50 or change the display positions thereof. Instead of changing the display ranges, different display times may be assigned to the windows so that they do not overlap with each other. Also in this case, the user can view all the windows having the same display priority without needing to switch between the windows.

When multiple windows overlap with each other to generate an overall image, the above-mentioned embodiment determines the order of overlapping windows using display priorities determined based on the display contents. When a window is displayed second or later in terms of the order of overlapping windows without changing the display content, changing the display content may assign the highest display priority to that window. The window is displayed at the top, making it easy to view the information in the window. Consequently, the user can promptly and easily recognize the necessary information.

### Second Embodiment

The following describes a second embodiment of the invention. The mutually corresponding parts in the second and first embodiments are designated by the same reference numerals and a detailed description is omitted for simplicity.

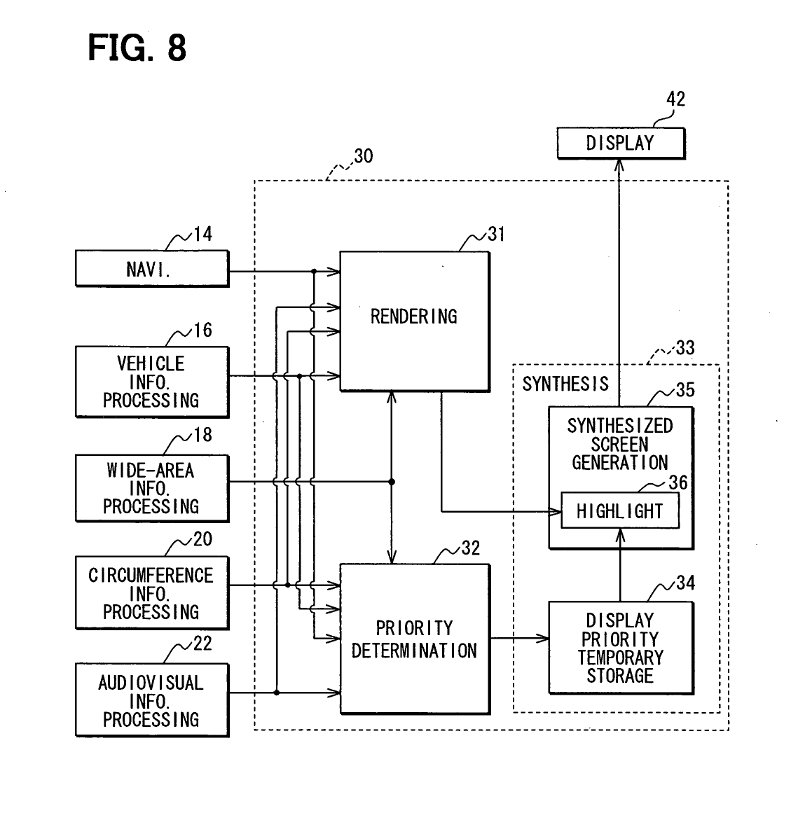

As shown in FIG. 8, the apparatus according to the second embodiment differs from that according to the first embodiment in that the synthesized screen generation unit 35 includes a highlight unit 36. The highlight unit 36 functions as highlight means. The top window may change to another when the display unit 42 displays multiple windows overlapping with each other. The highlight unit 36 determines whether or not the new top window displays a content with high urgency. That is, the highlight unit 36 determines whether or not the display priority for the window is greater than or equal to a predetermined value. The display priority is determined by the window's display content and the priority conversion table in FIG. 5.

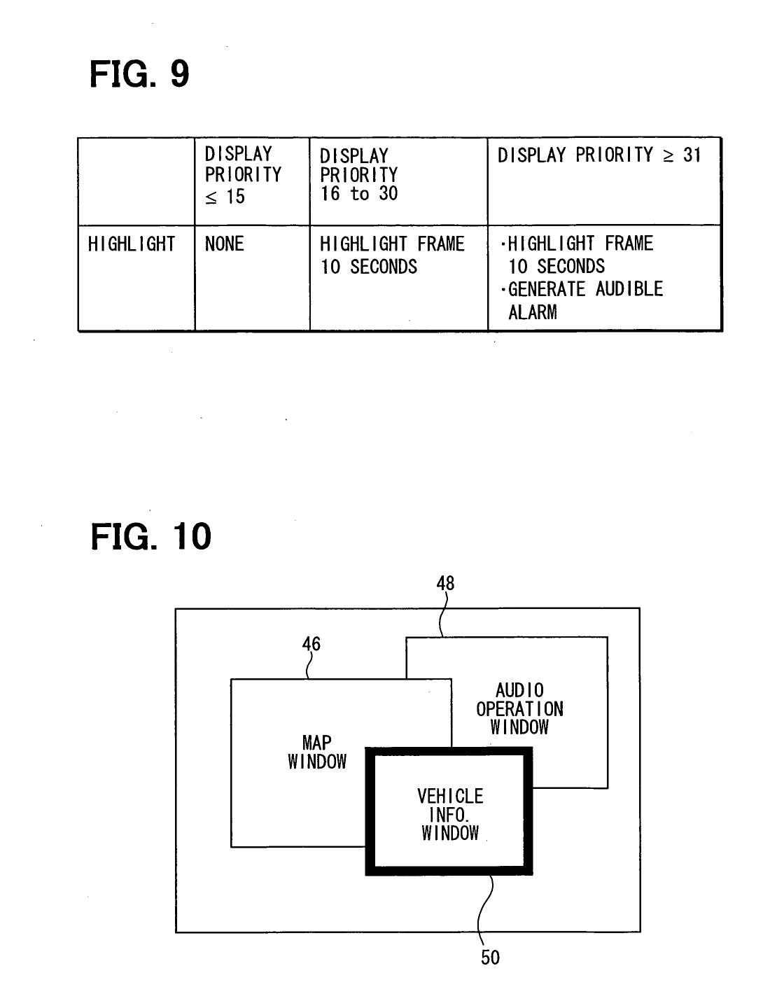

FIG. 9 exemplifies a highlight table used for the determination. The highlight unit 36 uses the highlight table in FIG. 9 to determine whether or not the display content is assigned high urgency. Specifically, the highlight unit 36 determines whether or not the window is assigned a display priority greater than 16. When the highlight table in FIG. 9 is used, the display content urgency is classified into three categories instead of simply two, high or low.

As a result of the determination using the highlight table in FIG. 9, the display content may be assumed to be highly urgent, i.e., the display priority may be assumed to be 16 or more. In this case, the highlight unit 36 highlights the window newly positioned at the top in highlight mode specified correspondingly to the display priority in the highlight table.

This will be further explained below using the same example as the first embodiment. Since the vehicle information window 50 contains the display content indicating “no error,” the synthesized screen is displayed at the top as shown in FIG. 4. Let us suppose that the display content of the vehicle information window 50 changes to “abnormal air pressure” and the display priority of the window 50 changes to 30 from 1.

In this case, the vehicle information window 50 is displayed at the top. Since the highlight unit 36 references the table in FIG. 9, the vehicle information window 50 highlights the display frame ten seconds. FIG. 10 shows the highlighted display frame of the vehicle information window 50. The display frame is thicker than that in FIG. 4.

The order of overlapping windows may be changed to newly display the topmost window having a highly urgent display content. In such case, the second embodiment highlights the display frame of the topmost window. The user can easily pay attention to that window. Accordingly, the user can quickly notice that the window shows the highly urgent information.

Let us assume that the new topmost window may be assigned display priority 31 or more. As shown in the highlight table of FIG. 9, the window's display frame is highlighted ten seconds and the speaker 44 generates a specified audible alarm. Accordingly, the user can more easily notice the highly urgent information.

### Third Embodiment

The following describes a third embodiment of the invention. The third embodiment differs from the second embodiment only in the use of a highlight table instead of the highlight table in FIG. 9.

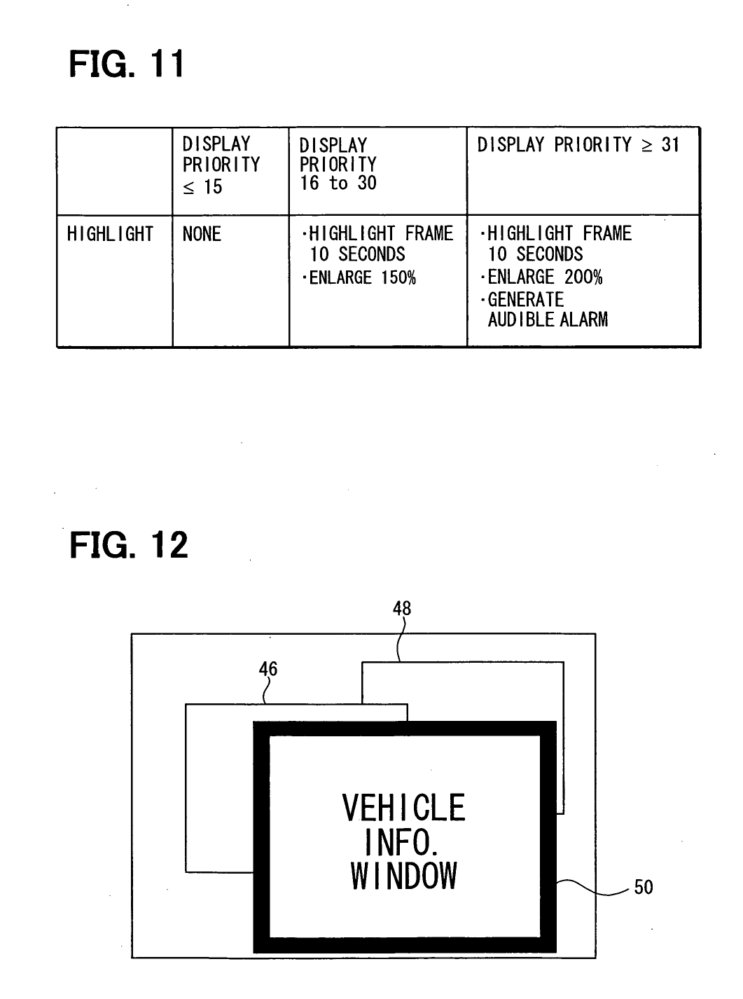

According to the highlight table in FIG. 9, the audible alarm is provided depending on display priorities but the window highlight mode is unchanged. The highlight table in FIG. 11 also provides different window highlight modes depending on display priorities.

Let us suppose that the display priority ranging from 16 to 30 is assigned to the window that references the highlight table in FIG. 11. The highlight unit 36 highlights the window's display frame ten seconds and increases a display scale 150% compared to that used for the display content before change. When the display priority is 31 or more, the highlight unit 36 highlights the display frame ten seconds. Further, the highlight unit 36 increases the display scale 200% compared to that used for the display content before change and allows the speaker 44 to generate a specified audible alarm.

This will be explained using the same example as the first embodiment. Since the vehicle information window 50 contains the display content indicating “no error,” the synthesized screen is displayed at the top as shown in FIG. 4. Let us suppose that the display content of the vehicle information window 50 changes to the display content with display priority 31 or higher. In this case, the vehicle information window 50 is displayed at the top. Since the highlight unit 36 references the table in FIG. 11, the vehicle information window 50 highlights its display frame ten seconds. In addition, the vehicle information window 50 is enlarged 200%. FIG. 12 shows this state. Further, the speaker 44 generates a specified audible alarm.

The third embodiment uses different highlighting mode (i.e., display scales in this third embodiment) depending on display contents. More urgent information becomes more remarkable than less urgent information. When especially highly urgent information is displayed, the user can more easily notice that information

### Fourth Embodiment

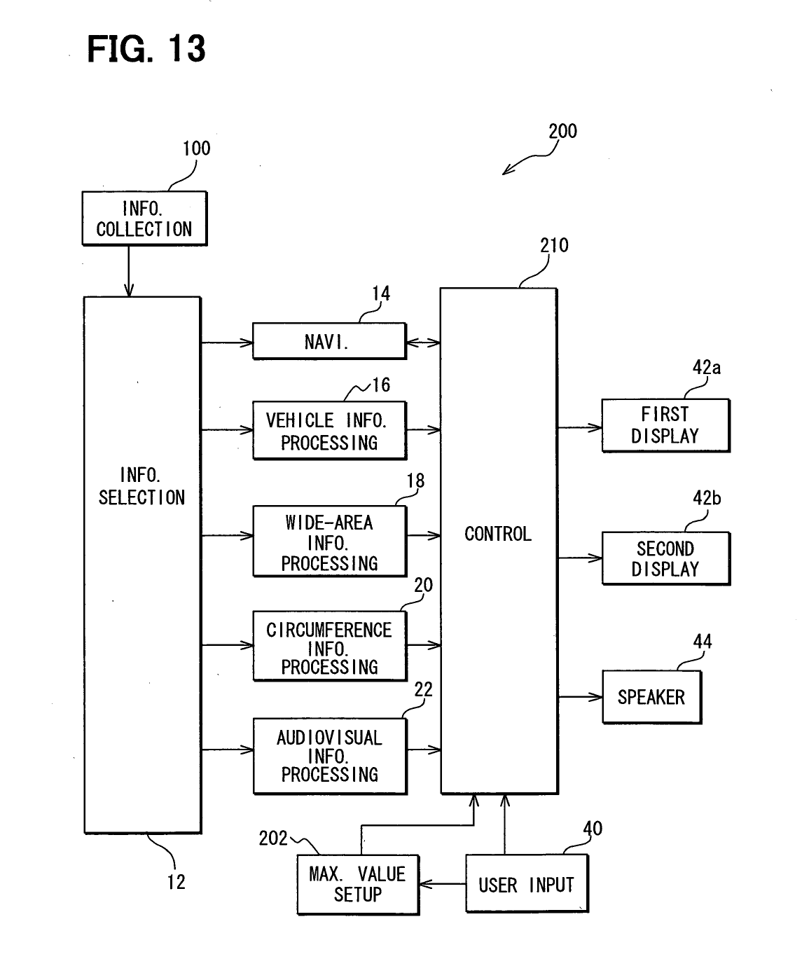

The following describes a fourth embodiment of the invention. FIG. 13 is a block diagram showing the construction of a display apparatus 200 according to the fourth embodiment. The display apparatus 200 differs from the display apparatus 10 in that the former has a maximum value setup unit 202. The function of a control unit 210 partly differs from the display apparatus 10. The other parts of the construction are the same as those in FIG. 1.

The maximum value setup unit 202 functions as maximum value setup means. For example, the maximum value setup unit 202 includes a computer having CPU, ROM, and RAM. The maximum value setup unit 202 is supplied with a specific value indicating the maximum number of windows displayed on the display unit 42. The maximum number of windows is supplied from the user input apparatus 40. When the value is input, the maximum value setup unit 202 specifies the value as a maximum display count of windows displayed on the display unit 42. The maximum value setup unit 202 outputs the specified maximum display count to the control unit 210. According to the embodiment, the maximum display count is a numeric value specifying the maximum number of windows displayed on the one display unit 42. The maximum display count may specify the maximum number of windows displayed on part (specified display range) of the display screen of the display unit 42.

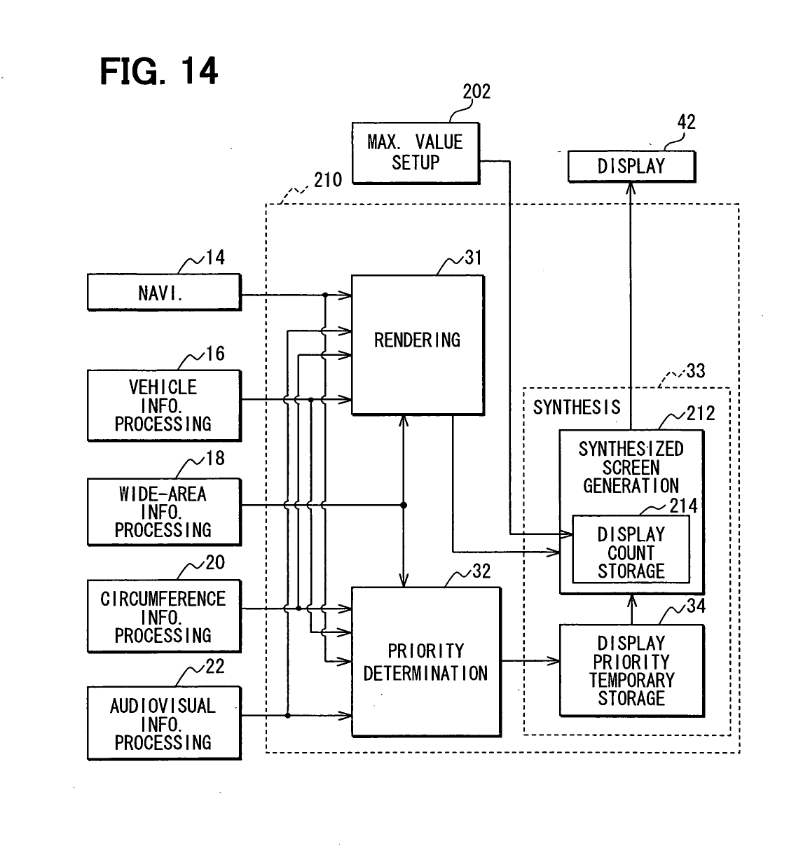

FIG. 14 is a block diagram showing in detail one of control functions of the control unit 210 in FIG. 13 as the display control unit. When FIGS. 14 and 3 are compared, there is only a difference between functions of the synthesized screen generation units 212 and 35 in FIGS. 14 and 3, respectively. The synthesized screen generation unit 212 has a maximum display count storage unit 214 for storing a maximum display count specified by the maximum value setup unit 202.

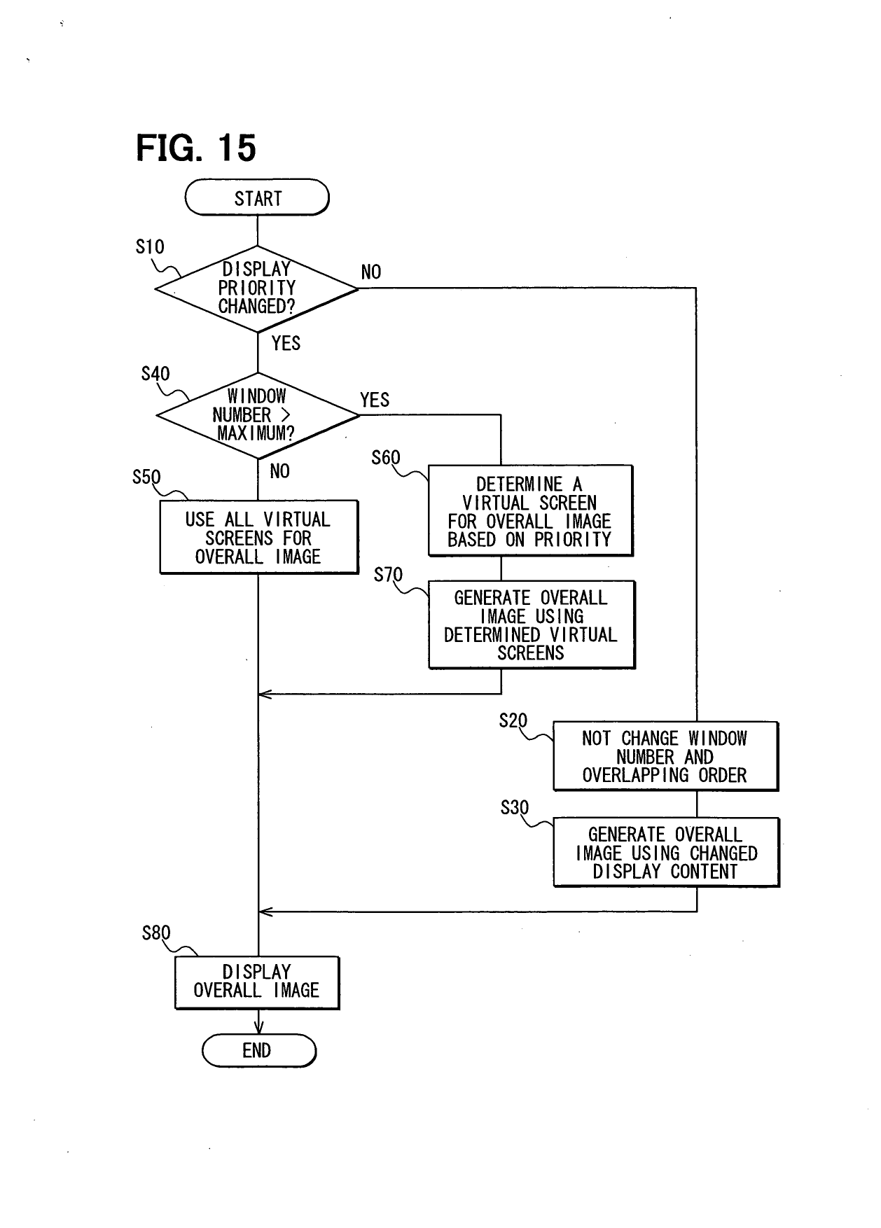

FIG. 15 is a flowchart showing a process of the synthesized screen generation unit 212. The process shown in the flowchart of FIG. 15 is performed when the rendering unit 31 changes the content of at least one virtual screen.

At Step S10, the synthesized screen generation unit 212 determines whether or not the priority determination unit 32 changed the display priority of the window having its display content changed. When the result of the determination at Step S10 is negative, the display priority is unchanged. In this case, at Step S20, synthesized screen generation unit 212 determines not to change the number of display windows and the order of overlapping windows. At Step S30, the synthesized screen generation unit 212 generates the overall image by changing only the window's display content without changing the type of window to be displayed and the order of overlapping windows.

When the result of the determination at Step S10 is affirmative, the process proceeds to Step S40. At Step S40, the synthesized screen generation unit 212 determines whether or not the number of windows to be displayed on the display unit 42 exceeds the maximum display count stored in the maximum display count storage unit 214. In this case, the rendering unit 31 determines the number of windows to be displayed on the display unit 42. When the result of the determination at Step S40 is negative, the process proceeds to Step S50. At Step S50, the synthesized screen generation unit 212 uses all the virtual screens determined by the rendering unit 31 to generate an overall image so as to display the window with a higher display priority stored in the display priority temporary storage unit 34.

When the result of the determination at Step S40 is affirmative, the process proceeds to Step S60. At Step S60, the synthesized screen generation unit 212 determines a virtual screen used for generation of the overall image based on the display priority stored in the display priority temporary storage unit 34. For example, let us suppose that the display count determined by the rendering unit 31 is by one greater than the maximum display count stored in the maximum display count storage unit 214. In this case, the synthesized screen generation unit 212 determines a virtual screen to be used for generation of the overall image so that the virtual screen is other than the one containing the window assigned the lowest display priority. At Step S70, the synthesized screen generation unit 212 generates the overall image by overlaying virtual screens determined at Step S60 in the order of display priorities stored in the display priority temporary storage unit 34.

At Step S80, the synthesized screen generation unit 212 supplies the display unit 42 with the overall images generated at Step S30, 50, and 70.

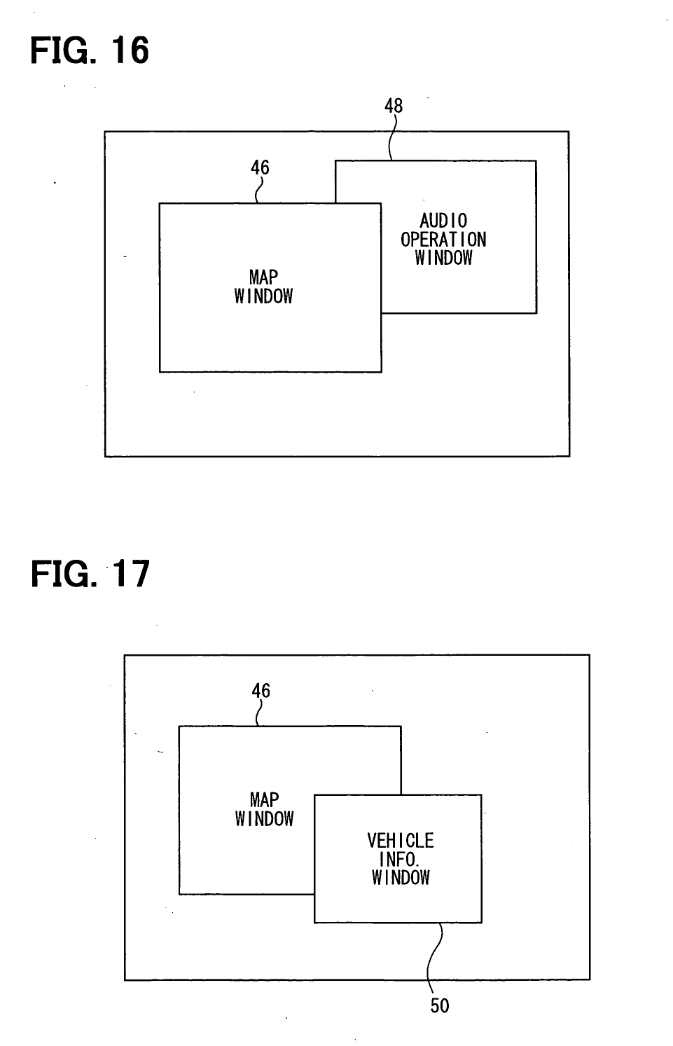

The following describes the display screen displayed on the display unit 42 according to the fourth embodiment using the same example as the first embodiment. While the virtual screens 1 to 3 are generated as shown in FIG. 4, the maximum display count may be set to 2. In this case, virtual screen 3 is not displayed based on the display priority. Only virtual screens 1 and 2 are used to generate the overall image. The display unit 42 displays the screen as shown in FIG. 16.

In this state, let us suppose that the vehicle information window 50 changes its display content with display priority 1 to the one with display priority 30. The generation of the overall image uses the vehicle information window 50 instead of the audio operation window 48. In addition, the vehicle information window 50 is higher than the map window 46 in terms of the order of overlapping windows. The display unit 42 displays the screen as shown in FIG. 17.

As mentioned above, the fourth embodiment limits the number of windows displayed on the one display unit 42. This improves visibility of all the displayed windows. The number of displayed windows is limited even when a specified window is determined to display important information with high display priority and is displayed on the top. This improves visibility of the important information.

### Fifth Embodiment

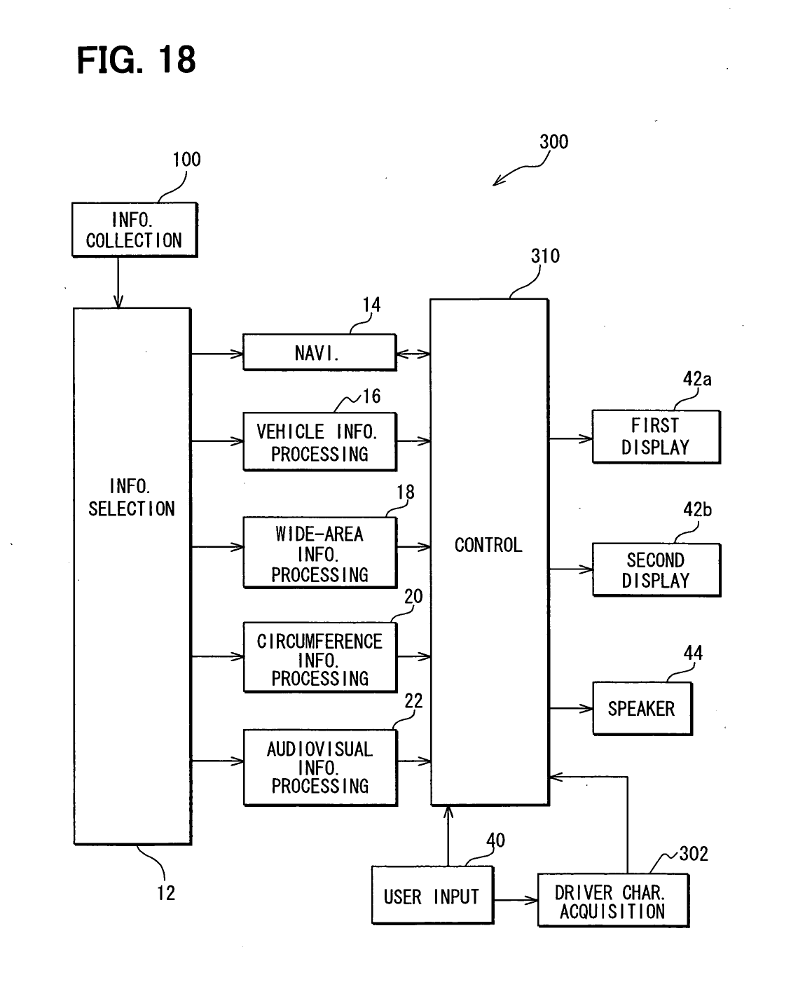

The following describes a fifth embodiment of the invention. FIG. 18 is a block diagram showing the construction of a display apparatus 300 according to the fifth embodiment. The display apparatus 300 differs from the display apparatus 10 in FIG. 1 in that the former includes a driver characteristics acquisition unit 302. The function of a control unit 310 partly differs from the display apparatus 10. The other parts of the construction are the same as those in FIG. 1.

The driver characteristics acquisition unit 302 acquires driver characteristics information, i.e., information about driver characteristics. A driver operates the vehicle-mounted user input apparatus 40 to input a signal. Based on this input signal, the driver characteristics acquisition unit 302 according to the embodiment acquires the driver characteristics information. The embodiment acquires the driver's gender and age as the driver characteristics information.

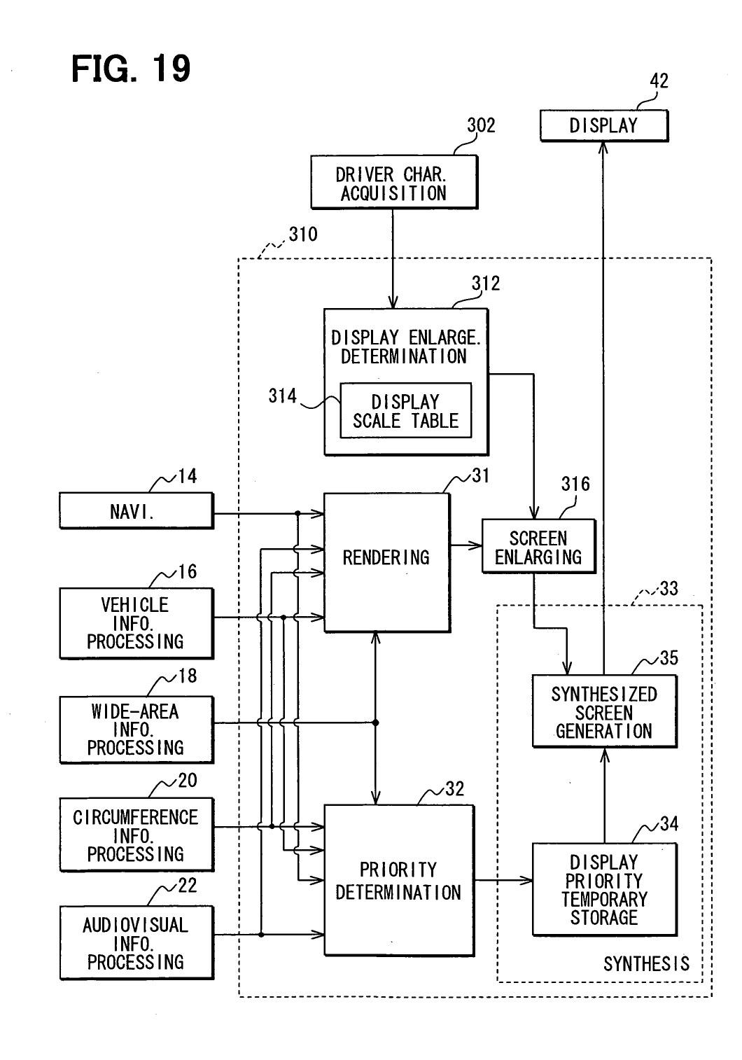

FIG. 19 is a block diagram showing in detail one of control functions of the control unit 310 in FIG. 18 as the display control unit. When FIGS. 19 and 3 are compared, FIG. 19 differs from FIG. 3 in that FIG. 19 includes a display enlargement determination unit 312 and a screen enlarging unit 316.

The display enlargement determination unit 312 includes a display scale table 314. Using the display scale table 314, the display enlargement determination unit 312 determines whether or not to enlarge each virtual screen created in the rendering unit 31 according to the driver characteristics information acquired by the driver characteristics acquisition unit 302. The display enlargement determination unit 312 also determines an enlargement factor of the virtual screen.

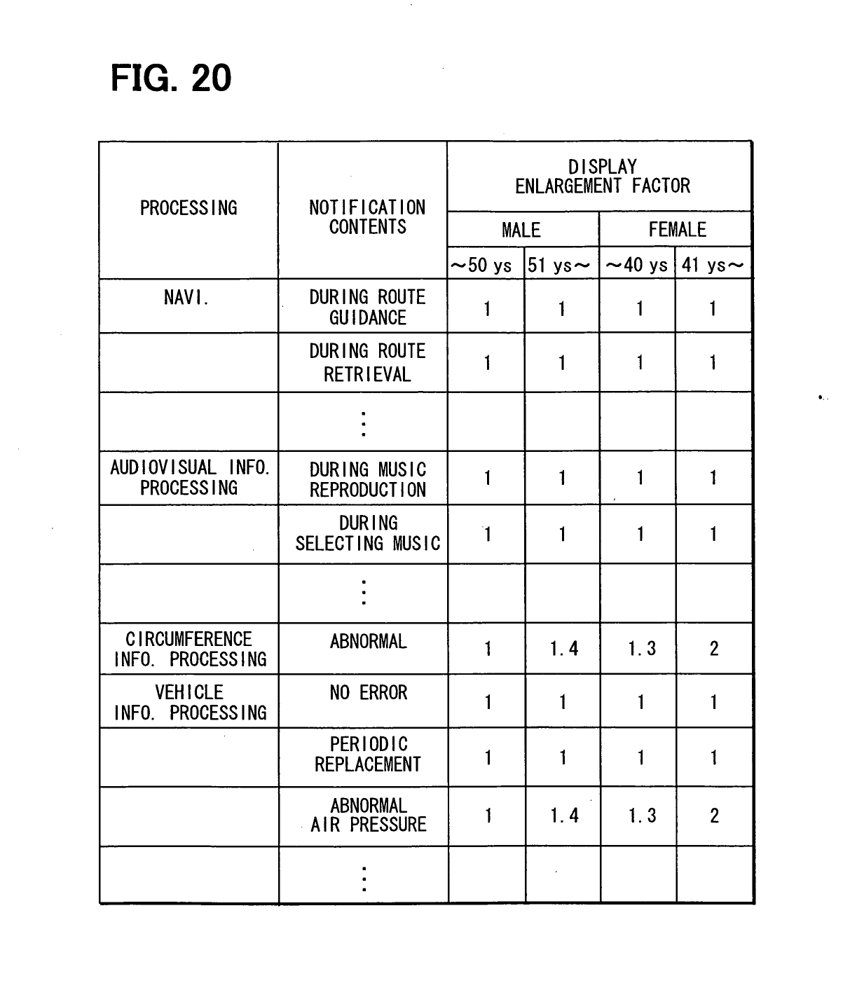

FIG. 20 is an example of the display scale table 314. The display scale table defines display enlargement factors corresponding to the processing units (i.e., the navigation unit 14 and the information processing units 16, 18, 20, and 22), their notification contents (display contents displayed in the windows), and the driver characteristics information. For example, the display scale table in FIG. 20 notifies an abnormal air pressure based on the display mode for a male driver aged 50 or younger. The display enlargement factor is multiplied 1.4 times for a male driver aged 51 or older. The display enlargement factor is multiplied 1.3 times for a female driver aged 40 or younger. The display enlargement factor is doubled for a female driver aged 41 or older.

The display enlargement factor is configured based on the fact that a female driver generally cannot afford to pay sufficient attention to the display screen of the display unit 42 than a male driver. In addition, an older driver needs a relatively long time to confirm the content of a small display. An enlarged display is used to fast notify the driver of highly urgent contents. The driver can easily understand the highly urgent information.

The screen enlarging unit 316 functions as highlight means. When the rendering unit 31 determines a virtual screen, the screen enlarging unit 316 enlarges that virtual screen with an enlargement factor determined by the display enlargement determination unit 312. The screen enlarging unit 316 supplies the enlarged screen to the synthesized screen generation unit 35.

The following describes the display screen displayed on the display unit 42 according to the fifth embodiment using the same example as the first embodiment. At a given time point, let us suppose that virtual screens 1 through 3 are generated as shown in FIG. 4 and the windows 46, 48, and 50 provide the same notification contents as those for the first embodiment. The display enlargement factor is determined based on the display scale table and is set to 1 for all the windows 46, 48, and 50 irrespectively of the contents of the driver characteristics information. Accordingly, the overall image is generated as shown at the top in FIG. 4.

When the content of the vehicle information window 50 changes to “abnormal air pressure,” the vehicle information window 50 is assigned the highest display priority. The overall image is changed so that the vehicle information window 50 is displayed at the top. When the driver characteristics acquisition unit 302 acquires the driver characteristics information about a male driver aged 50 or younger, the display enlargement factor remains 1 for all the windows 46, 48, and 50. The overall image is changed only as to the order of the overlapping windows 46, 48, and 50. The overall image is displayed as shown in FIG. 6.

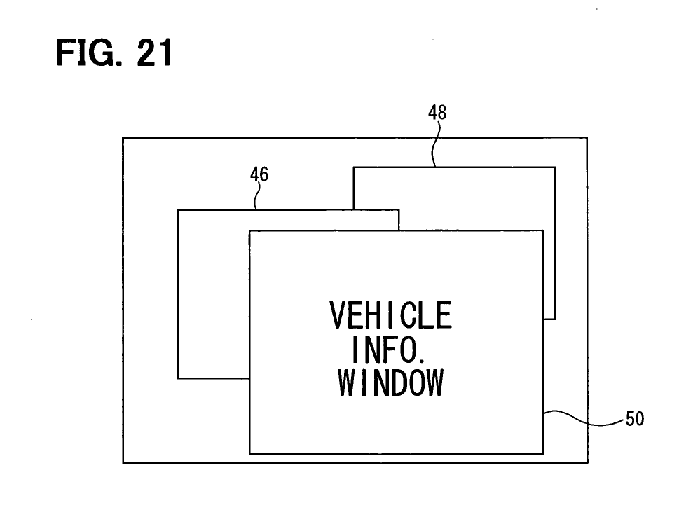

When the driver characteristics acquisition unit 302 acquires the driver characteristics information about a female driver aged 41 or older, the display enlargement factor changes to 2 for the vehicle information window 50. The vehicle information window 50 is positioned at the top and is doubled in size. FIG. 21 exemplifies the overall image at this time.

The fifth embodiment uses different window enlargement factors for important display contents depending on the driver characteristics information. The top window is enlarged for display when the driver is generally considered to be less experienced and not to afford to pay sufficient attention to the display screen. The driver can acquire important information in a short period of time.

### Sixth Embodiment

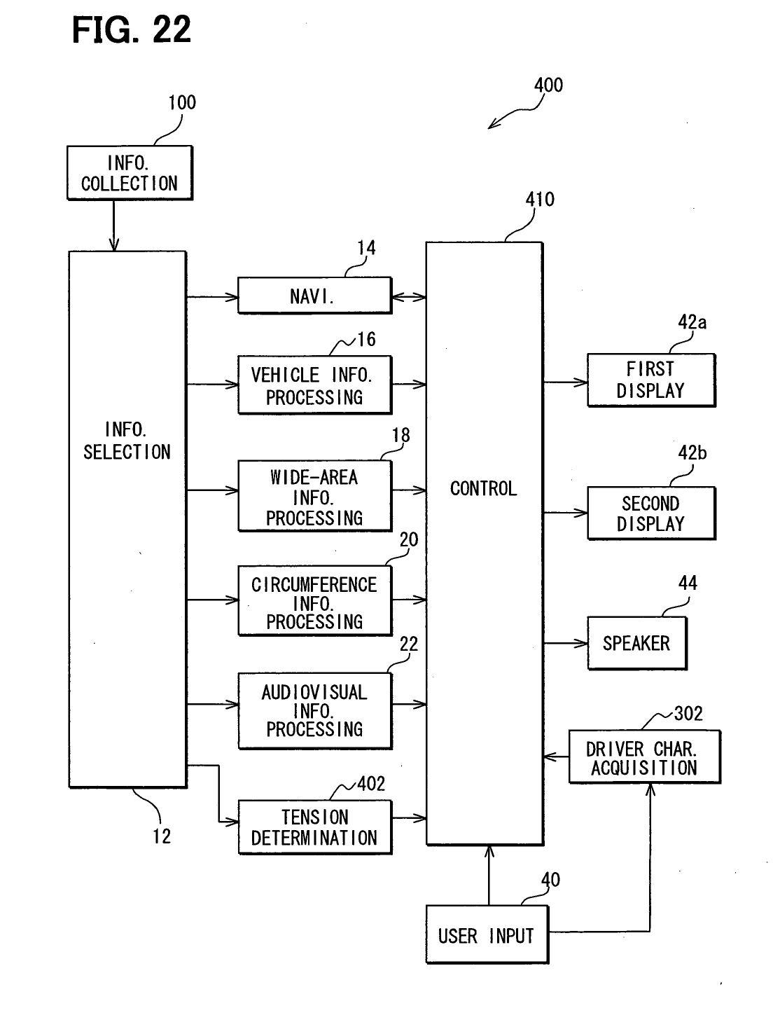

The following describes a sixth embodiment of the invention. FIG. 22 is a block diagram showing the construction of a display apparatus 400 according to the sixth embodiment. The display apparatus 400 differs from the first through fifth embodiments in that the display apparatus 400 further includes a tension determination unit 402 as the information processing unit. The function of a control unit 410 partly differs from the first through fifth embodiments. The other parts of the construction are the same as those in FIG. 1.

The tension determination unit 402 functions as tension determination means. The tension determination unit 402 is supplied with a signal from the biologic information sensor 127 via the information selection unit 12. The tension determination unit 402 uses the supplied signal to chronologically detect the driver's heart rate. Based on a change in the heart rate, the tension determination unit 402 determines whether or not the driver is tense. To do this determination, for example, the tension determination unit 402 finds an average heart rate as a reference in a stable state where a range of heart rate variations is smaller than a specified value. When the heart rate increases for a specified value or specified rate from the reference, the tension determination unit 402 determines that the driver is tense. The determination result is input to the control unit 410.

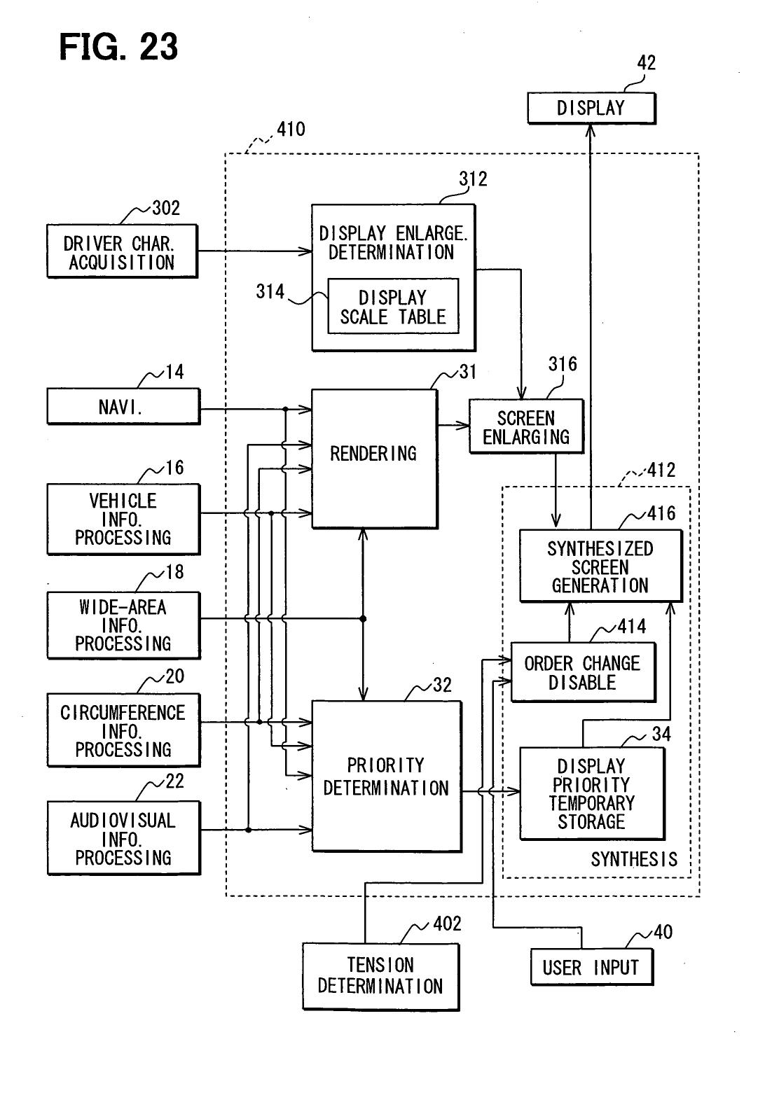

FIG. 23 is a block diagram showing in detail one of control functions of the control unit 410 in FIG. 22 as the display control unit. In FIG. 23, a process in the synthesis unit 412 differs from that in the preceding embodiments. The synthesis unit 412 includes order change disable means 414 and a synthesized screen generation unit 416 in addition to the above-mentioned display priority temporary storage unit 34.

The tension determination unit 402 may determine that the driver is tense. Further, the user may operate the user input apparatus 40 to control the window displayed at the top of the display screen. In such cases, the order change disable means 414 determines to inhibit a change in the order of overlapping windows. The order change disable means 414 supplies the synthesized screen generation unit 416 with an instruction for inhibiting the order of overlapping windows from being changed. The driver may be then relieved from the tense state. Alternatively, the user may complete the operation concerning the topmost window. In such cases, the order change disable means 414 supplies the synthesized screen generation unit 416 with an instruction to release the instruction for inhibiting the order of overlapping windows from being changed.

The synthesized screen generation unit 416 is supplied with a virtual screen from the rendering unit 31 via the screen enlarging unit 316. The synthesized screen generation unit 416 generates an overall image by overlapping one or more supplied virtual screens in the order of display priorities stored in the display priority temporary storage unit 34. A change may be made to the display priority stored in the display priority temporary storage unit 34 to necessitate a change in the order of overlapping virtual screens. In this case, the synthesized screen generation unit 416 determines whether or not an order change disabling state takes effect. When the order change disabling state is inactive, the synthesized screen generation unit 416 regenerates the overall image by changing the order of overlapping virtual screens based on the updated display priority. The order change disabling state takes effect during a period from when the order change disable means 414 issues the instruction for inhibiting the order of overlapping windows from being changed to when the order change disable means 414 issues the instruction for releasing that inhibiting instruction.

The order change disabling state may be active even when there is a need for changing the order of overlapping virtual screens. In such case, the synthesized screen generation unit 416 generates the overall image by overlapping the virtual screens without changing the overlapping order.

The order change disabling state may be inactive even when the rendering unit 31 generates an increased number of virtual screens. In such case, the synthesized screen generation unit 416 generates the overall image by determining the order of overlapping virtual screens based on the display priority of an added virtual screen and the display priorities of the remaining virtual screens. When the order change disabling state is active, the synthesized screen generation unit 416 does not add a virtual screen until the order change disabling state is released.

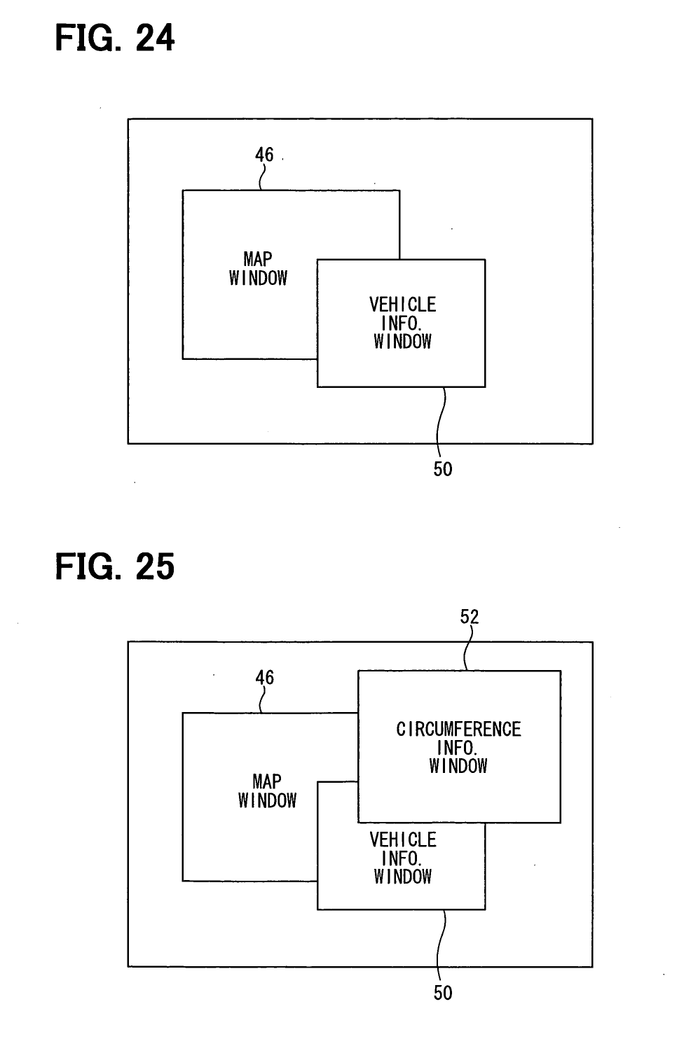

The following uses an example to describe the display screen displayed on the display unit 42 according to the sixth embodiment. At a given time point, let us suppose that the map window 46 and the vehicle information window 50 are displayed as shown in FIG. 24. The map window 46 and the vehicle information window 50 are assigned display priorities 10 and 1, respectively.

The circumference information processing unit 20 detects an error around the vehicle. Based on the detection result, the rendering unit 31 may generate an additional virtual screen containing a circumference information window 52 (see FIG. 25) for notifying the error around the vehicle. In this case, the display unit 42 displays the screen as shown in FIG. 25. On the screen in FIG. 25, the circumference information window 52 is assigned display priority 30. Therefore, the circumference information window 52 is displayed at the top.

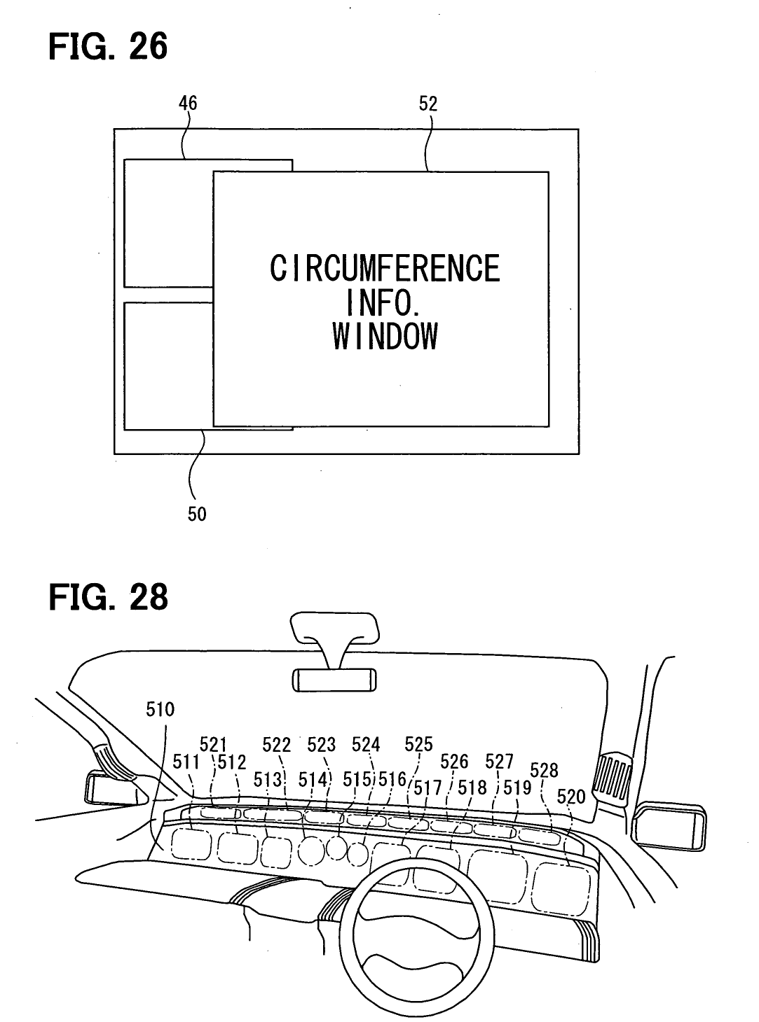

FIG. 25 shows an example of a male driver aged 50 or younger. The display enlargement factor is set to 1 as shown in the display scale table of FIG. 20. When the driver is female aged 41 or older, the screen in FIG. 26 is displayed instead of the screen in FIG. 25. The circumference information window 52 in FIG. 26 is enlarged twice as large as that in FIG. 25.

The example in FIG. 26 displays an enlarged version of the circumference information window 52. When the display positions of the map window 46 and the vehicle information window 50 are unchanged, these windows are hardly viewed. To solve this problem, the display positions of the windows 46 and 50 are moved so that these windows overlap with the topmost circumference information window 52 as hardly as possible.

When the topmost window is manipulated, the sixth embodiment temporarily inhibits a change in the order of overlapping windows. While a window is being manipulated, the sixth embodiment prevents that window from being hidden from the other windows. When the driver is assumed to be tense, the embodiment also inhibits a change in the order of overlapping windows. When the driver is too tense to control driving, a change in the order of overlapping windows may draw the driver's attention to the display screen and may cause careless driving. The embodiment can decrease such possibility.

### Seventh Embodiment

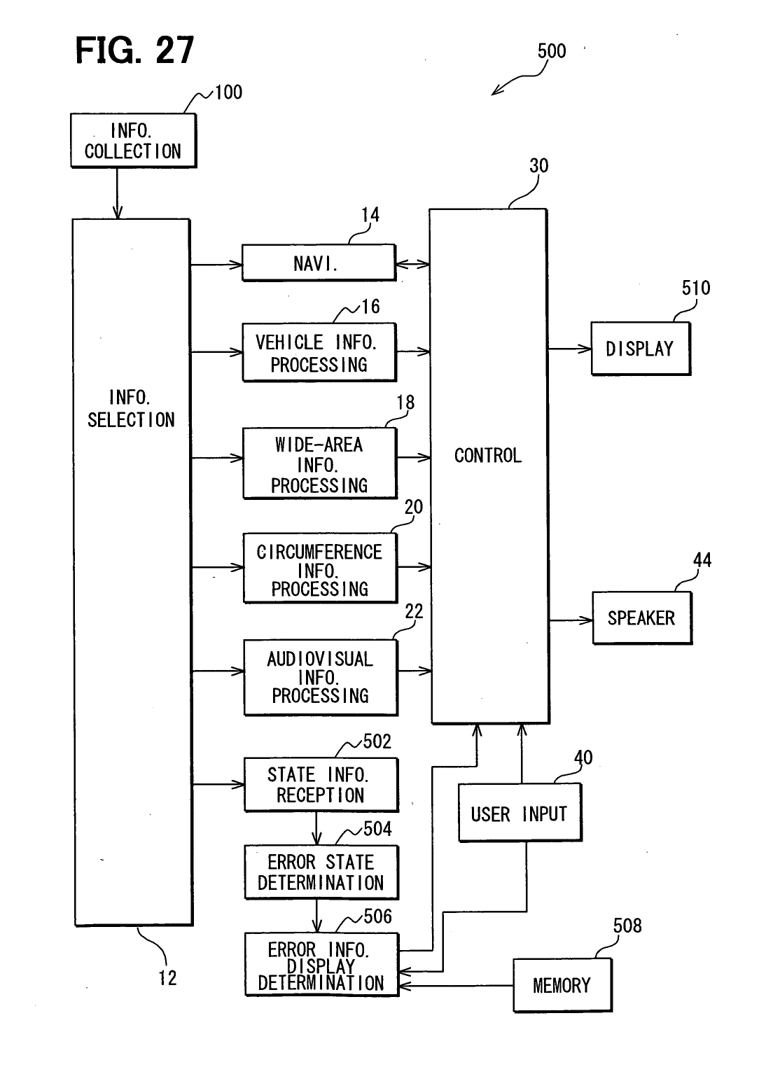

The following describes a seventh embodiment of the invention. FIG. 27 is a block diagram showing the construction of a display apparatus 500 according to the seventh embodiment. The display apparatus 500 differs from the display apparatus 10 according to the first embodiment in that the former further includes a state information reception unit 502, an error state determination unit 504, an error information display determination unit 506, and a memory unit 508. As another difference, the display unit 510 is provided under a windshield as shown in FIG. 28 and is approximately as long as the vehicle compartment in the width direction. The display unit 510 represents a liquid crystal display and includes many display areas 511 through 528. The display areas 511 through 528 display various information such as a speedometer, a fuel gauge, a tachometer, an image around the vehicle, a traffic regulation indication, a route guidance indication, traffic congestion information, and vehicle anomaly information as needed. It is possible to vary the number of display areas 511 through 528, their sizes, and types of information displayed on them as needed.

The state information reception unit 502 receives predetermined information out of the information output from the information collection unit 100. The received information is used to determine a vehicle error such as a vehicle failure. For example, the state information reception unit 502 receives the same information as for the vehicle information processing unit 16. In addition to the information collection unit 100 as shown in FIG. 2, there are further provided a battery voltage sensor, an exhaust gas sensor, an air suspension sensor, a water temperature sensor, an engine oil sensor, and a boost sensor (boost pressure sensor). The state information reception unit 502 may receive values output from these sensors.

The error state determination unit 504 determines a vehicle error based on the information received by the state information reception unit 502. When the error state determination unit 504 determines the vehicle error, the error information display determination unit 506 supplies the control unit 30 with specified screen data for notifying the error content. Based on a signal from the error information display determination unit 506, the control unit 30 displays a determination result from the error state determination unit 504 on the corresponding display areas 511 through 528 in the display unit 510.

For example, the display area 523 displays a determination result from the error state determination unit 504. It is difficult to find where urgent information such as a vehicle anomaly is displayed on the many display areas 511 through 528 of the display unit 510 as shown in FIG. 28. When the error state determination unit 504 determines the vehicle anomaly, the error information display determination unit 506 highlights a display mode more intensely than a case where no vehicle anomaly is determined. In this case, the error information display determination unit 506 references an error information priority table stored in the memory unit 508 to determine the display mode.

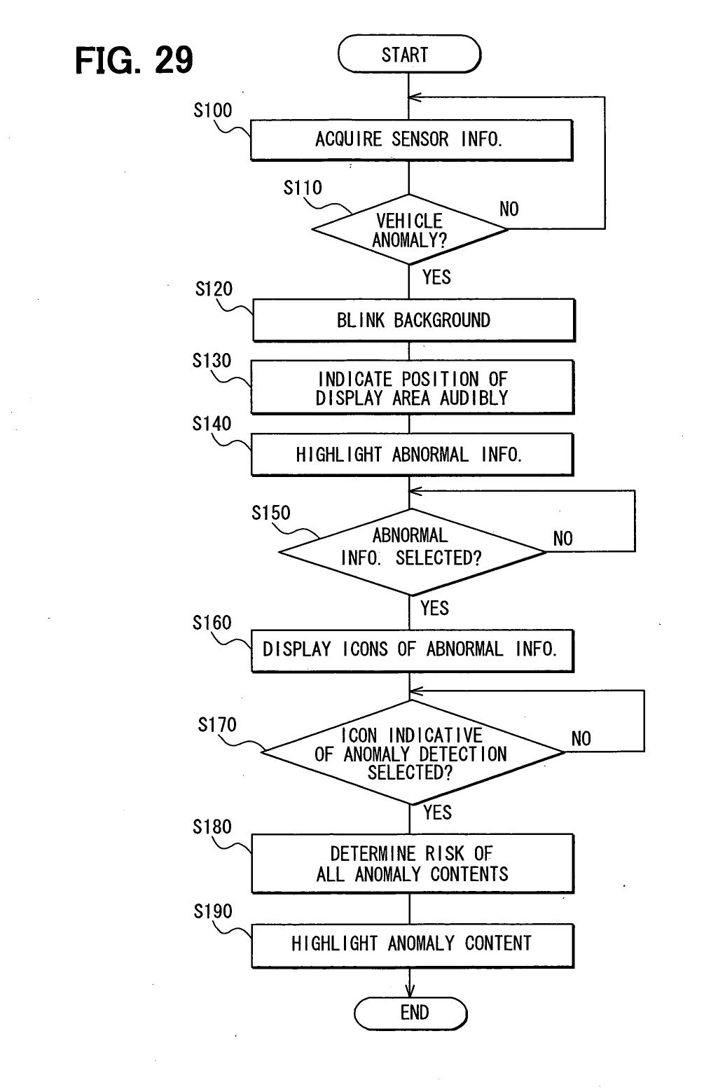

FIG. 29 is a flowchart showing processes in the state information reception unit 502, the error state determination unit 504, and the error information display determination unit 506. In FIG. 29, Step S100 corresponds to the process in the state information reception unit 502. Step S110 corresponds to the process in the error state determination unit 504. Step S120 and later correspond to the process in the error information display determination unit 506.

At Step S100, the state information reception unit 502 acquires (receives) sensor information from a specified sensor. At Step S110, the error state determination unit 504 uses the sensor information acquired at Step S100 to determine a vehicle anomaly. When the result of the determination at Step S110 is negative, Step S100 and later are repeated.

When the result of the determination at Step S110 is affirmative, the process proceeds to Step S120. At Step S120, the error information display determination unit 506 blinks the background of a specified display area (display area 523 in this example) for displaying the vehicle anomaly.

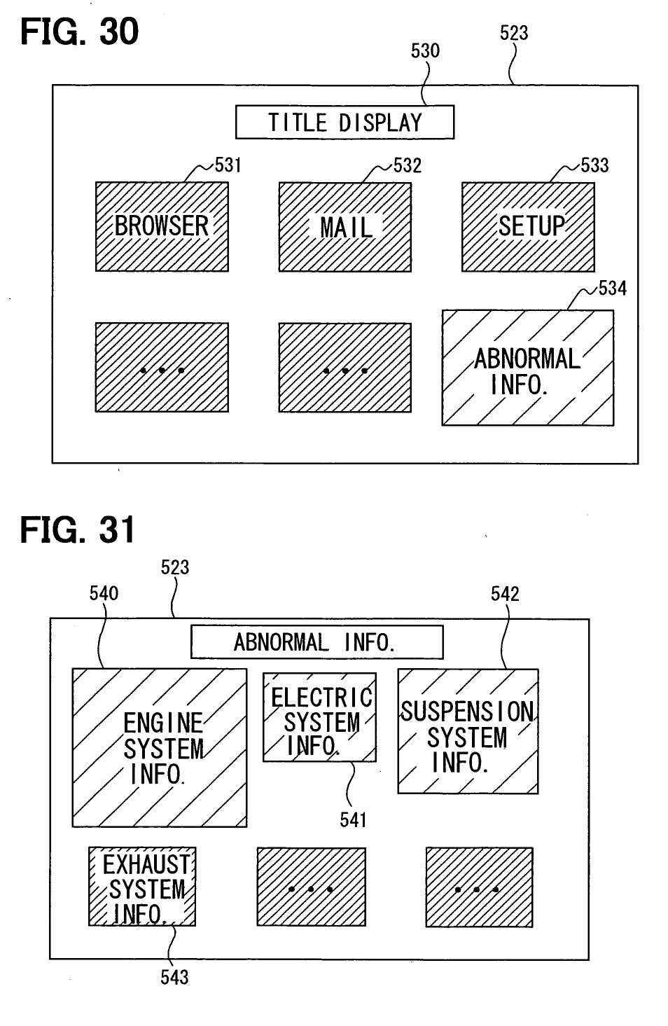

FIG. 30 is a display example of the display area 523. The display area 523 includes small display areas for showing a title display area 530 and various icons such as a browser icon 531, a mail icon 532, a setup icon 533, and an abnormal information icon 534. In the display area 523, a part other than the small display areas is the background. At Step S120, the background blinks.

At Step S130, the error information display determination unit 506 audibly indicates the position of the display area 523. At Step S140, the error information display determination unit 506 highlights the abnormal information icon 534. FIG. 30 shows an example of the display area 523 after execution of Step S140. In FIG. 30, the abnormal information icon 534 is displayed larger and brighter than the other icons 531 through 533. In a normal state where no vehicle anomaly is determined, the abnormal information icon 534 is displayed with the same size and brightness as the other icons 531 through 533. The highlight mode is not limited to the example in FIG. 30 and may be provided as changing the color, blinking, or changing the display frame.

Since the abnormal information icon 534 is highlighted at Step S140, the driver can be notified that a vehicle anomaly is detected. The embodiment further blinks the periphery of the abnormal information icon 534 and audibly indicates the display position. The driver can be fast notified of the vehicle anomaly and the display position of the abnormal information icon 534.

The error information display determination unit 506 highlights the abnormal information icon 534 at Step S140 and then determines at Step S150 whether or not the abnormal information icon 534 is selected. To perform this determination, a touch switch is integrated with the display unit 510 and detects that the driver presses the abnormal information icon 534.

When the result of the determination at Step S150 is negative, the process at Step S150 is repeated. When the result of the determination at Step S150 is negative, the error information display determination unit 506 displays the next screen at Step S160. FIG. 31 shows a display example in the display area 523 after execution of Step S160.

The display area 523 in FIG. 31 displays icons indicative of abnormal information corresponding to respective systems. The icons include the engine system information icon 540, an electric system information icon 541, a suspension system information icon 542, and an exhaust system information icon 543. The exhaust system information icon 543 is displayed in a display mode indicating that the exhaust system is normal. When no error is determined, the other icons 540, 541, and 542 are also displayed in the same size and brightness as the exhaust system information icon 543.

In FIG. 31, however, the engine system information icon 540, the electric system information icon 541, and the suspension system information icon 542 are displayed in a mode different from the display mode for the exhaust system information icon 543. That is, the icons 540, 541, and 542 are displayed larger and brighter than the exhaust system information icon 543. This indicates that anomalies are detected in the engine, electric, and suspension systems.

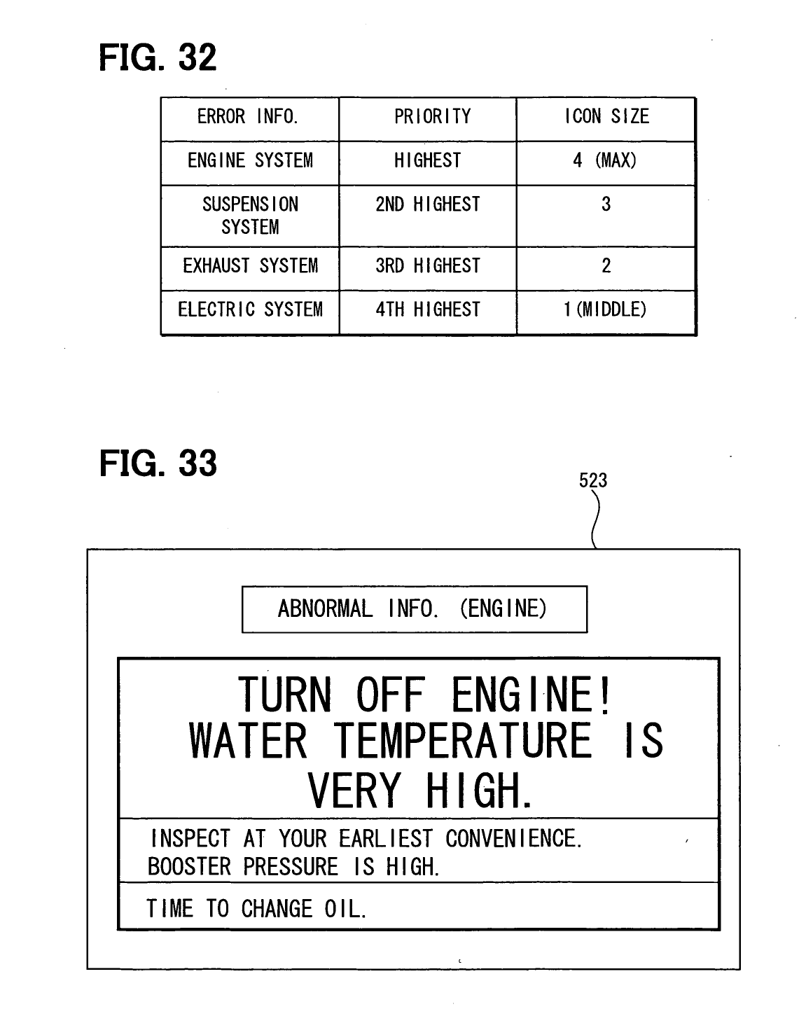

The icons 540, 541, and 542 are sized based on the error information priority table stored in the memory unit 508. FIG. 32 exemplifies the error information priority table. The error information priority table in FIG. 32 defines the priority and the size of the icon corresponding to the abnormal system. The engine system has the highest priority and uses the largest icon. The priority decreases in the order of the suspension, exhaust, and electric systems. When an anomaly is determined, the icon size decreases in this order.

Referring back to FIG. 29, the error information display determination unit 506 displays the display area as shown in FIG. 31 at Step S160. At Step S170, the error information display determination unit 506 then determines whether or not the icon indicative of anomaly detection is selected. (That is, such icon is one of the engine system information icon 540, the electric system information icon 541, and the suspension system information icon 542 in the example of FIG. 31.)

When the result of the determination at Step S170 is negative, the process at Step S170 is repeated. When the result of the determination at Step S170 is affirmative, the error information display determination unit 506 uses a predetermined risk determination table to determine the risk of all anomaly contents defined for the system indicated by the selected icon at Step S180. The risk determination table classifies anomaly contents into (1) anomaly immediately affecting running, (2) anomaly not immediately affecting running, and (3) parts replacement.

After the risk determination at Step S180, the process proceeds to Step S190. At Step S190, the display area 523 displays the next screen that highlights a specific anomaly content corresponding to the risk of the anomaly content. FIG. 33 shows a display example of the display area 523 corresponding to Step S190 when the engine system information icon 540 is selected.

The example in FIG. 33 shows three engine system anomalies correspondingly to the top, middle, and bottom. The top corresponds to the above-mentioned anomaly (1). The middle corresponds to the above-mentioned anomaly (2). The bottom corresponds to the above-mentioned anomaly (3). The anomaly (1) is indicated with a letter double as large as that for the anomalies (2) and (3). The anomaly (2) is indicated in boldface. The risk may be indicated in a variety of colors in addition to or instead of the size and thickness of letters. For example, the anomaly (1) may be indicated in red, (2) in yellow, and (3) in blue.

The driver may take specified action for the anomaly or repair or replace parts so as not to detect the anomaly. In such case, the display content of the display area 523 returns to the normal display content. (That is, the screen in FIG. 30 will contain the abnormal information icon 534 resized to the other icons in FIG. 30.)

(Modifications)

For example, the sixth embodiment allows the user to input the driver characteristics information. Further, a storage apparatus may be used to store the driver characteristics information about multiple driver candidates. A camera may be used to capture a driver's image to identify the driver. It may be preferable to determine the actual driver's driver characteristics information from the driver characteristics information about multiple driver candidates stored in the storage apparatus. The driver characteristics information may further include a driving experience as well as the above.

The fourth embodiment may use the storage apparatus to store the relationship between the driver characteristics information and the maximum display count. The driver characteristics information can be determined based on a user's input operation as described in the sixth embodiment. Alternatively, the driver characteristics information can be determined from the driver characteristics information about multiple driver candidates based on the image recognition as mentioned above. The maximum display count may be configured according to the determined driver characteristics information and the above-mentioned relationship.

The seventh embodiment determines the driver's tense state based on a change in the heart rate. It may be preferable to determine the driver's tense state based on a change in the blood pressure instead of or in addition to the heart rate.

Each or any combination of processes, steps, or means explained in the above can be achieved as a software unit (e.g., subroutine) and/or a hardware unit (e.g., circuit or integrated circuit), including or not including a function of a related device; furthermore, the hardware unit can be constructed inside of a microcomputer.

Furthermore, the software unit or any combinations of multiple software units can be included in a software program, which can be contained in a computer-readable storage media or can be downloaded and installed in a computer via a communications network.

It will be obvious to those skilled in the art that various changes may be made in the above-described embodiments of the present invention. However, the scope of the present invention should be determined by the following claims.

What is claimed is:

1. A display apparatus comprising:
screen determination means for determining information that includes a number of windows to be displayed in a display screen, a display range in each window, and a display content in each window;
image generation means for generating an overall display image for the display screen based on information determined by the screen determination means and displaying the generated image on the display screen; and
priority determination means for determining a display priority of a window based on a display content included in information determined by the screen determination means,
wherein, when the screen determination means determines displaying a plurality of windows having display ranges to overlap with each other, the image generation means generates an overall image by determining an order of overlapping the plurality of windows based on display priorities determined by the priority determination means.

2. The display apparatus according to claim 1, further comprising:
highlight means for highlighting using a different display mode a topmost window, which has a predetermined highly urgent display content and appears topmost among a plurality of windows overlapping to each other after an order of overlapping the plurality of windows is changed.

3. The display apparatus according to claim 2,
wherein the highlight means provides a different highlighting mode according to a display content.

4. The display apparatus according to claim 2,
wherein a speaker generates a specified sound for notifying a change in the order of overlapping the plurality of windows in synchronization with window highlighting by the highlight means.

5. The display apparatus according to claim 1,
wherein, when the priority determination means determines a plurality of windows assigned a highest display priority and the screen determination means determines display ranges of the plurality of windows so as to overlap with each other, the image generation means displays the plurality of windows assigned with the highest display priority so as not to overlap with each other.

6. The display apparatus according to claim 1, further comprising:
maximum value setup means for setting a maximum display count of windows displayed in a specified display range of the display screen,
wherein, when a number of windows determined by the screen determination means exceeds the maximum display count, the image generation means generates an overall image using windows corresponding to the maximum display count in an order of display priorities determined by the priority determination means, and
wherein, when the screen determination means changes a window display content, the image generation means regenerates an overall image based on a display priority determined by the priority determination means.

7. The display apparatus according to claim 6,
wherein the maximum value setup means configures a maximum display count using a display count inputted by a user.

8. The display apparatus according to claim 6, further comprising:
a storage apparatus that stores a relationship between specific characteristic information about a driver's characteristic and a maximum display count,
wherein the maximum value setup means configures a maximum display count based on an actual characteristic information about a driver and the relationship stored in the storage apparatus.

9. The display apparatus according to claim 2,
wherein the highlight means provides a different highlighting mode according to specific characteristic information about a driver's characteristic.

10. The display apparatus according to claim 1,
wherein even when the priority determination means changes a window's display priority to necessitate to change an order of overlapping windows, the image generation means does not change the order of overlapping windows while a user manipulates a topmost window among the windows overlapping.

11. The display apparatus according to claim 1, further comprising:
tension determination means for determining whether or not a driver is tense,
wherein even in a case that the priority determination means changes a window's display priority to necessitate to change an order of overlapping windows, the image generation means does not change the order of overlapping windows when the tension determination means determines that a driver is tense.

12. The display apparatus according to claim 1,
wherein the display screen includes a plurality of display areas, and
wherein, when normal information displayed in a certain display area of the plurality of display areas changes to predetermined abnormal information, a display mode for the certain display area is changed.

13. The display apparatus according to claim 12,
wherein, when normal information displayed in the certain display area changes to predetermined abnormal information, a different display mode is also used for a periphery of the certain display area.

14. The display apparatus according to claim 12,
wherein, when normal information displayed in the certain display area changes to predetermined abnormal information, a display location of the certain display area is audibly notified.

15. A display apparatus in a vehicle, the apparatus comprising:
a plurality of display areas as a display screen for simultaneously displaying information; and
a display control unit for controlling displaying information in the display screen,
wherein, when normal information displayed in a certain display area of the plurality of display areas changes to predetermined abnormal information, the display control unit changes a display mode for the certain display area.

16. The display apparatus according to claim 15,
wherein, when normal information displayed in the certain display area changes to predetermined abnormal information, a different display mode is also used for a periphery of the certain display area.

17. The display apparatus according to claim 15,
wherein, when normal information displayed in the certain display area changes to predetermined abnormal information, a display location of the certain display area is audibly notified.

18. A method for displaying information, comprising:
determining information that includes a number of windows to be displayed in a display screen, a display range in each window, and a display content in each window;
determining a display priority of each window based on a display content of each window, when a plurality of windows having display ranges to overlap with each other are determined to be displayed;
generating an overall display image for the display screen by determining an order of overlapping the plurality of windows based on display priorities determined; and
displaying the generated image on the display screen.

19. A display apparatus comprising:
a display unit having a display screen;
a screen determination unit that determines information that includes a number of windows to be displayed in the display screen, a display range in each window, and a display content in each window;
an image generation unit that generates an overall display image for the display screen based on information determined by the screen determination unit and displays the generated image on the display screen; and
a priority determination unit that determines a display priority of a window based on a display content included in information determined by the screen determination unit,
wherein, when the screen determination unit determines displaying a plurality of windows having display ranges to overlap with each other, the image generation unit generates an overall image by determining an order of overlapping the plurality of windows based on display priorities determined by the priority determination unit.
